(19) United States
(12) Patent Application Publication
(10) Pub. No.: US 2019/0250619 A1
(43) Pub. Date: Aug. 15, 2019

(54) AUTONOMOUS BICYCLE

(71) Applicant: Carla R. Gillett, Sacramento, CA (US)

(72) Inventor: Carla R. Gillett, Sacramento, CA (US)

(73) Assignee: Carla R. Gillett, Sacramento, CA (US)

(21) Appl. No.: 16/370,981

(22) Filed: Mar. 30, 2019

Related U.S. Application Data
(63) Continuation-in-part of application No. 15/451,405, filed on Mar. 6, 2017, now Pat. No. 10,245,937.

(51) Int. Cl. G05D 1/02; B62K 23/02; B62L 3/02; B62M 6/50; B62M 6/90; B62J 99/00; B62J 3/00; B62J 6/00; H04W 76/14

(52) U.S. Cl. CPC G05D 1/0212; H04W 4/80; B62L 3/02; B62M 6/50; B62M 6/90; B62J 99/00; B62J 3/00; B62J 6/00; G05D 1/0278; G05D 1/0231; G05D 1/0257; H04W 76/14; B62J 2099/0013; B62J 2099/002; B62K 23/02

(57) ABSTRACT

An autonomous bicycle comprising an autonomous controller system comprising software associated with monitoring operational processes of one or more electric powered wheels governed by an environmental sensor array and motion sensors contained on framework sections, sensors including; load sensors, deformation sensors, gyroscope sensor, and accelerators, accordingly a power control module provides battery power to the electric motors. The autonomous bicycle configured to independently operate with or without an operator riding onboard. The operator uses their smartphone to manually control or verbally control the autonomous bicycle, the operator accesses a mobile app, customizes user preference settings, whereby software algorithms and user interface instructions allow the operator to control their autonomous bicycle when riding, or summon the autonomous bicycle to drive over to her or him, respectively the operator can utilizes their preference settings to select a custom drive mode with max speed calculated. The operator's smartphone is configured with a user interface system linked to the autonomous bicycle by WIFI or Bluetooth, the operation data and performance data gathered by the operator is saved in memory, Cloud management network, or Global Internet Network providing Cloud Database Management Network(s).

### CROSS REFERENCED TO RELATED APPLICATIONS

A notice of issuance for a continuation in part patent application in reference to application Ser. No. 15/451,405; filing date: Mar. 6, 2017; title: Vehicle Comprising Autonomous Steering Column System; and relating to patent applications; Ser. No. 13/872,054; filing date: Apr. 26, 2013, title: “Robotic Omniwheel”, and in reference to patent application Ser. No. 12/655,569; title: “Robotic Omniwheel Vehicle” filing date: Jan. 4, 2010, U.S. Pat. No. 8,430,192 B2.

### FIELD OF THE INVENTION

The present invention relates to a controller for providing a motorized bicycle wirelessly linking to a user interface system, a mobile app, a mobile phone or a combination thereof. The autonomous bicycle controller system preferably provides path planning to a semi-manual controlled autonomous bicycle.

### BACKGROUND OF THE INVENTION

Existing motorized bicycles work well only for situations relating to joy riding. What is needed is a smarter bicycle with trucks that are controlled by an autonomous control system with minimal user instruction which will allow the motorized bicycle to be capable of path planning autonomously and pick its own path by environmental tracking and object detection sensors. New methodologies are required for path planning for motorized bicycles which work manually and/or autonomously to follow from a starting point to an ending point by means of autonomous control system sensors and by GPS waypoints which are created from user interface input or created by a global network system.

### SUMMARY OF THE INVENTION

The present invention provides a manual control mode and an autonomous control mode selection for an operator not on board, or a rider onboard to control an autonomous bicycle, the autopilot methodology programmed to govern one or more navigation processes of an autonomous bicycle. Preferably, the autonomous bicycle provides WIFI or Bluetooth linking a user interface system to an autonomous bicycle controller system, the ABCS gathers environmental sensor data from the autonomous bicycle, the sensor data includes including short range LIDAR sensor, cameras, GPS, etc. for calculating motorized speed, compass heading, absolute position, relative position, and other environment sensor data. Further, the autonomous bicycle controller system includes a processing unit having software for computing logic a central processing unit, memory, storage, communication signals and instruction. Preferably, a potential operator wanting to ride an autonomous bicycle may summon the autonomous bicycle to drive directly to the her or him and while riding, the operator utilizes may engage their smartphone to access their personalized user interface system settings. The user interface system including electronic identification information and instruction, input and output data, and mechanical identifiers based on machine-readable identification information and electronic identifiers for automatically controlling the autonomous bicycle. The operator may wish to upload software or review a summary of the important information useful for operator and store performance data to Cloud management network, Global Internet Network providing Cloud Database Management Network(s).

### BRIEF DESCRIPTION OF THE DRAWINGS

FIG. 1 illustrates a perspective view of an autonomous bicycle 100 according to an aspect of the present invention.

FIG. 2A illustrates a perspective side view of an autonomous bicycle framework 102 according to an aspect of the present invention.

FIG. 2B illustrates a perspective view of a steering column and control panel arrangement according to an aspect of the present invention.

FIG. 2C illustrates a see-through side view of the framework sections 102 providing a battery compartment arrangement in accordance with one or more embodiments of the present invention.

FIG. 3 illustrates a schematic diagram representing a Gravity Control Mode 300 according to an aspect of the present invention.

FIG. 4 schematically illustrates a diagram representing an Autonomous Bicycle Controller System 400 according to an aspect of the present invention.

FIG. 4A and FIG. 4B details flowcharts representing operational processes of an Autonomous Bicycle Controller System 400 according to an aspect of the present invention.

FIG. 5A schematically illustrates a diagram representing an Autonomous Bicycle Motion Control Mode 500 disclosing operational processes according to an aspect of the present invention.

FIG. 5B schematically illustrates a flowchart representing operation steps of the Autonomous Bicycle Motion Control Mode 500 according to an aspect of the present invention.

FIG. 6A, FIG. 6B, and FIG. 6C schematically represent flowcharts for operation steps the Autonomous Bicycle Drive Mode 600 according to an aspect of the present invention.

FIG. 7 schematically illustrates a flowchart representing operations of a Manual Drive Mode 700 according to an aspect of the present invention.

FIG. 8A exemplifies a User Interface System 800 steps to establish wireless communication link between an operator 101 of an autonomous bicycle 100 according to an aspect of the present invention.

FIG. 8B schematically illustrates a flowchart 800 representing operations of an Autonomous Bicycle User Interface System 800 according to an aspect of the present invention.

FIG. 9 schematically illustrates a diagram representing operations of an Autonomous Bicycle Smartphone APP 900 according to an aspect of the present invention.

### DETAILED DESCRIPTION OF THE DRAWINGS

The present invention includes an autonomous bicycle 100 that accomplishes one or more tasks with or without guidance from an operator 101 when riding, when the operator has stepped off, or the autonomous bicycle operator may summon one or more autonomous bicycles to drive to where the operator is or wherever operator directs. The period of full autonomous control may range from a less than a minute to an hour or more. In various aspects the Autonomous Bicycle Controller System 400 is associated with an Autonomous Drive Mode 600 setting and a Manual Drive Mode 700 setting, the Autonomous Drive Mode 600 or the Manual Drive Mode 700 are engaged or disengaged by an operator's instructions by means of a smartphone comprising mobile apps, the mobile apps including personal riding app, or a networking rental system.

In various riding events, during an operation of an autonomous bicycle 100, the operator 101 may opt to utilize their smartphone 801 to access one or more user interface preference settings via a User Interface System 800 wirelessly linking to a mobile phone app or “smartphone app”.

During a networking rental system, the operator is associated with mobile phone operating system providing a user login, a verification of payment for rental minutes, etc. The autonomous bicycle operator/renter 101 is contracted and responsible for controlling the rented autonomous bicycle either manually or autonomously for short distances.

During a personal riding the autonomous bicycle operator 101 is associated with controlling her or his autonomous bicycle either manually or autonomously, when she or he prefers, for short distances the operator may prefer to manually control their autonomous bicycle 100, and when riding for longer distances the operator may prefer to not want to manually control their autonomous bicycle 100 therefore she or he can disengage the manual drive and engage the autonomous dive mode, accordingly in any riding event the operator 101 decides a drive mode option.

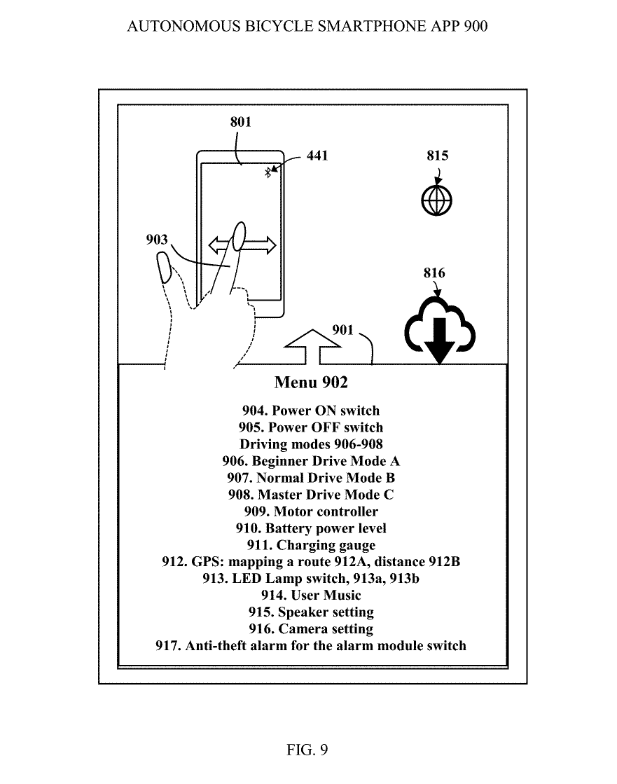

Respectively, the operator 101 of the autonomous bicycle 100 accesses control settings by her or his Bluetooth connected smartphone 801, the smartphone 801 is configured with user preference settings based on various Smartphone APP software, the software programming is associated with wirelessly controlling one or more electric motors 109 of the autonomous bicycle 100, in retrospect, the Smartphone APP or related mobile app is provided on the internet of things, an example of the Smartphone App 900 is detailed in FIG. 9.

Accordingly hereon the autonomous bicycle controller system 400 may be referred to as (ABCS), the autonomous bicycle 100 or (AB), (AB 100).

In various elements the autonomous bicycle 100 include WIFI and/or Bluetooth connectivity adapted for linking the User Interface System 800 (UIS) to the ABCS 400, wherein a built-in Bluetooth communication mode 802 is associated with a communication link between the autonomous bicycle 100 and operator's Smartphone APP 900, and provides a wireless link to one or more environmental sensors and processors associated ABCS drive control methodologies, the AB 100 is detailed herein.

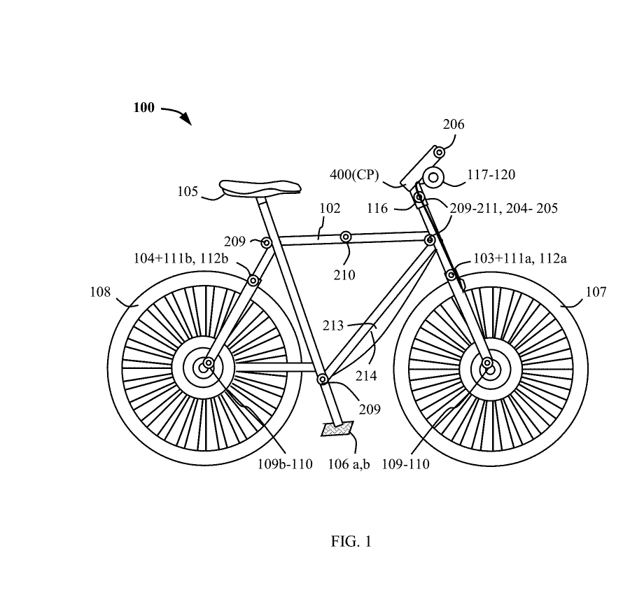

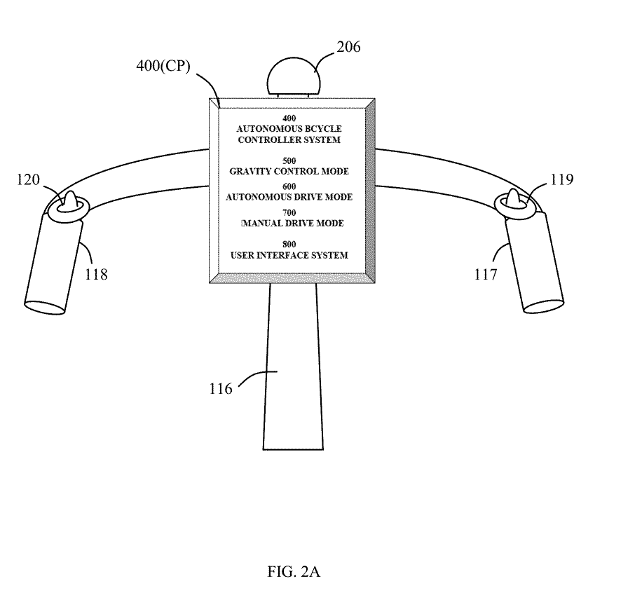

In greater detail FIG. 1A illustrates a perspective view of an autonomous bicycle 100A and an operator of the autonomous bicycle 100 as shown the operator 101 is exemplified utilizing a smartphone 801 for accessing the ABCS and autonomous drive mode 600 settings, furthermore, the autonomous bicycle 100 comprises a framework 102 providing a front end 103 and a rear end 104, a seat 105 providing left and right foot pegs 106.

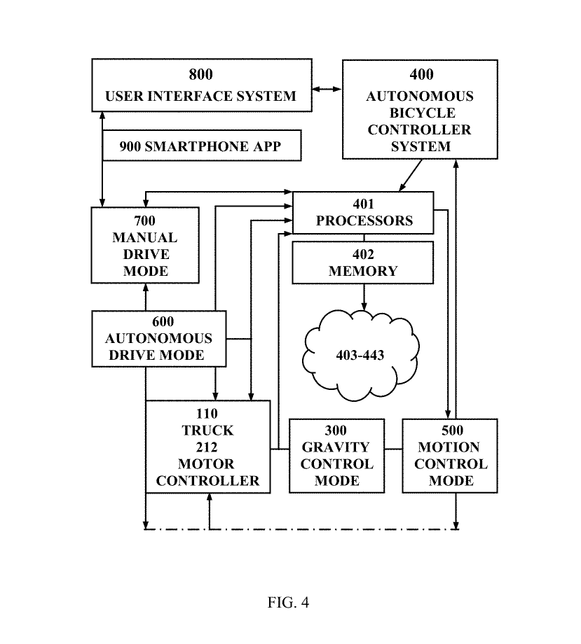

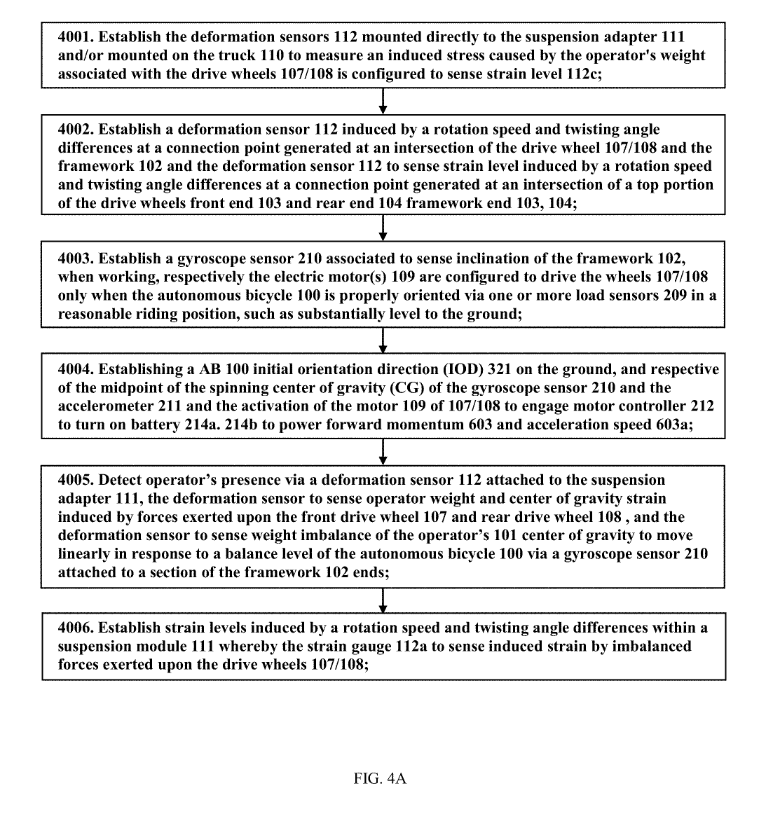

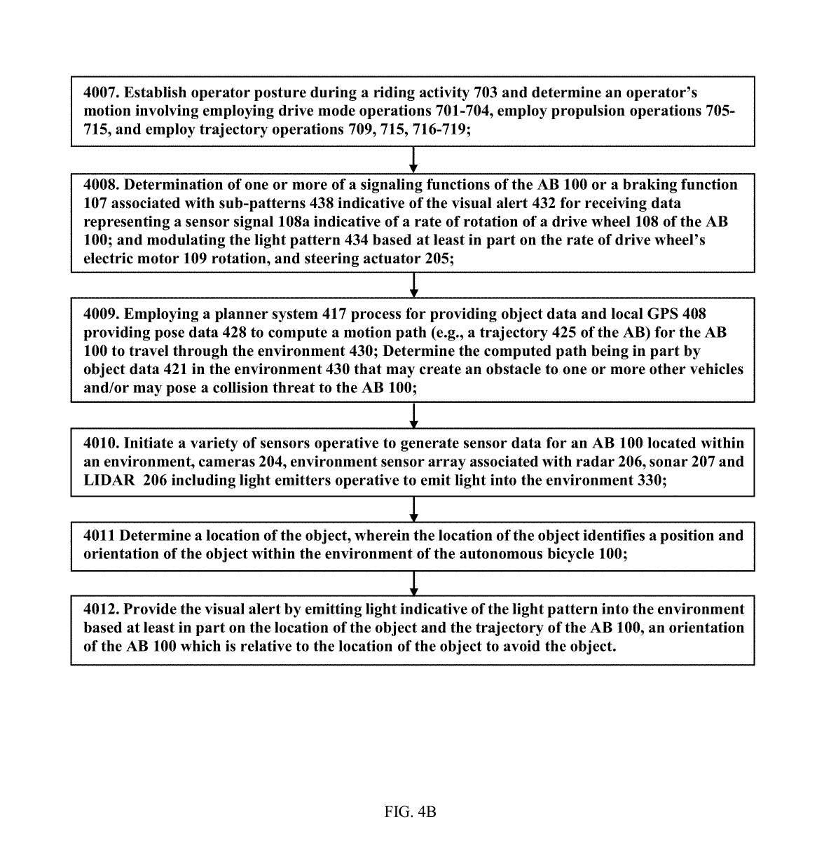

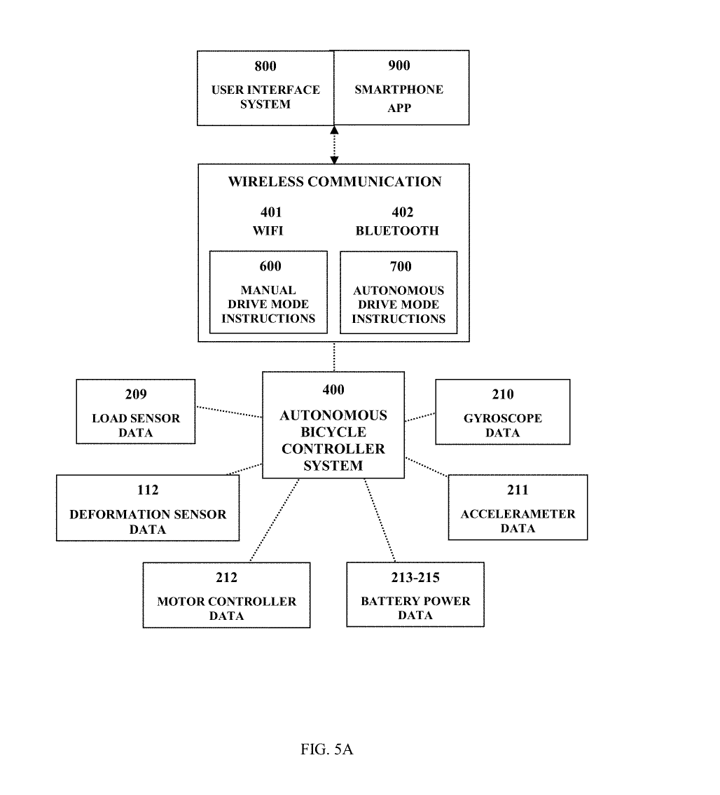

The framework's front end 103 and a rear end 104 for attaching a front drive wheel 107 and rear drive wheel 108, each drive wheel comprising a motor 109 and a brake 110, the drive wheel comprising a motor sensor 109a and a brake sensor 110a, and suspension fork 111 providing a connection at the drive wheel axis, and a deformation sensor 112 contained within a section on an upper portion of the suspension fork 111, the drive wheels 107 and 108 comprises an axle configured with bearings and bolting means for coupling a motor 109 and brake arrangement thereon. Accordingly, the front and rear drive wheels 107/108 are configured with steering actuator 113 and motor controllers 212a, 212b linking with one or more load sensors 209 and environment sensor array, see FIG. 4.

In various elements, the deformation sensor 112 to sense strain level 112b induced by an operator's weight exerted on the front drive wheel 107 and rear drive wheel 108 during autonomous drive mode running maneuvers.

Accordingly, the load sensors 209 are contained on the foot pegs 106a, 106b, respectively the loads sensors link to gyroscope sensor 210 providing an intelligent weight and motion controlling means configured to measure balance which is achieved as soon as the operator 101 steps on one or both feet on the foot pegs 106a, 106b.

Subsequently when operator 101 is detected stepping on one or both foot pegs 106, the load sensors 209 accordingly activate to begin furnishing battery power to the drive wheel motor 109, wherein the load sensors 209 link to the power control module 213, the motor controller 212a or 212b, which governed by operator 101, ABCS 400 or a combination of both.

Subsequently when operator 101 dismounts or is not detected on the foot pegs 106, the load sensors 209 deactivate and to stop furnishing battery power to the drive wheel motor 109.

In various elements the framework comprises a deformation sensor 112 is associated with the suspension fork 111 motion, velocity and trajectory control operations, wherein the front suspension fork 111a supports a front drive wheel 107, wherein a rear suspension fork 111b supports a rear drive wheel 108, (e.g., the drive wheels may be configured having spokes, tires, a rigid rim, a flexing rim or a combination thereof).

In various elements the framework's front end 103 couples the suspension fork 111a to an intersection of the steering column 116, respectively the deformation sensor 112b to sense strain level induced by a rotation speed and twisting angle differences at a connection point generated at the intersection of the steering columns base 121 and the front drive wheel 108. In various elements, the deformation sensor 112b to sense strain level induced by a rotation speed and twisting angle differences at a connection point generated at the intersection of the rear suspension fork 111b and the framework's rear end 105.

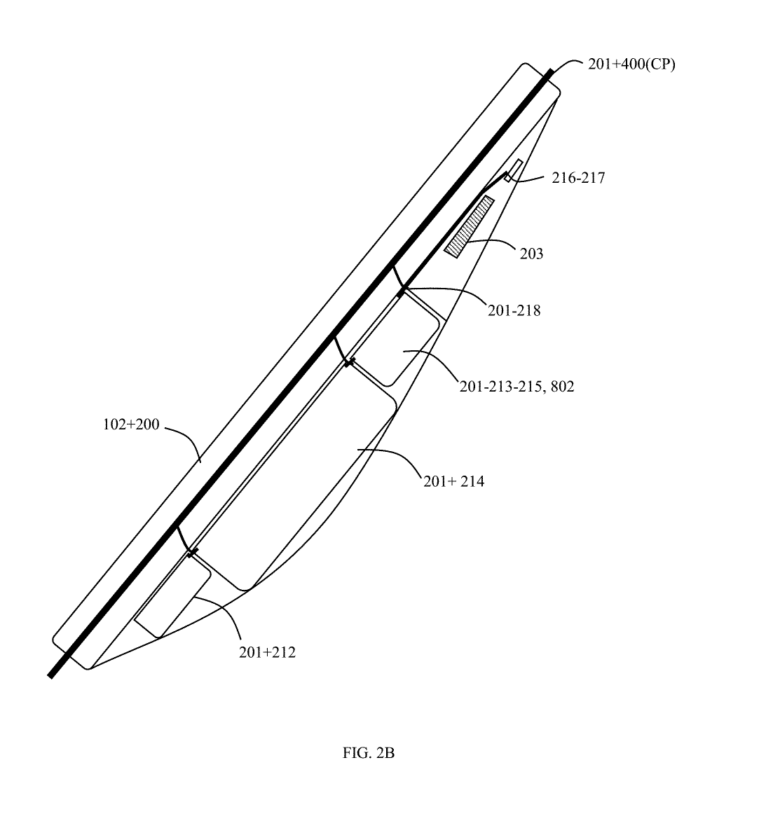

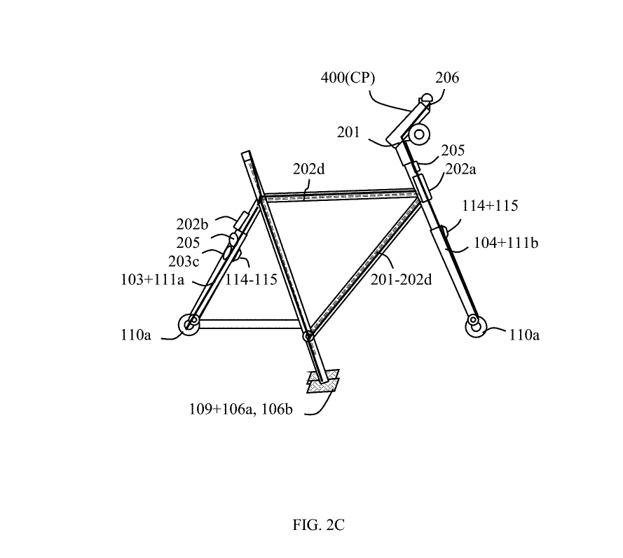

In various elements the framework further comprises a steering column, the steering column 116 comprises a and control panel 200 and a right handle 117 and a left handle 118. The control panel 400(CP) containing the control system components disclosed in FIG. 2 and FIG. 4. The steering column 116 is further configured with a base portion 121 and coupling means 122 for attaching or detaching the steering column 116 onto the front suspension fork 111a, front drive wheel 107 and brake 110 arrangements.

The framework further comprising a steering column 116, which is employed to steer the autonomous bicycle during autonomous drive mode operation by means of a steering actuator 205. The steering actuator 205 is utilized when the operator is temporally utilizing the manual drive mode not engaged, is some events the steering actor is autonomously engaged by the ABCS when the operator is distracted or not onboard, whereby the ABCS immediately engages the autonomous drive mode, accordingly the autonomous drive mode works to temporarily steer the AB 100 in the environment 330 until the operator gains manual control, if not the ABCS deactivates the AB autonomous drive mode 600 correspondingly with UIS 800.

The operator 101 during a semi-manual control operation of the manual drive mode 700, the AB operator 101 may select one or more methods for controlling steering motion and velocity motion, whereby the operator may manually engage both foot pegs 106a, 106b in a synchronized manner to adjust the speed to her or his riding level, whereby the AB operator 101 may manually engage the thumb throttle 119 or the left thumb brake lever 120 to control velocity, whereby the operator 101 may manually engage the right handle and the left handle to control steering and trajectory.

The steering columns right handle 117 supports a right thumb throttle 119 and the left handle 118 supports a left thumb brake lever 120, during manual drive mode and the throttle and level assist the operator to control speed and trajectory, and the steering columns handles are utilized by the AB operator 101 for manually steering the AB 100, respectively just like riding in a vehicle with a foot and brake pedal just technologically smarter.

Another control method is to use the above described method to sense CG but to increment or decrement a torque set point in a torque controller loop instead of a speed loop 320. The operator 101 would lean forward to increment the commanded torque set point and lean back to decrement the commanded torque set point; the rate of increment/decrement may be determined by the amplitude of the CG from center of the foot pegs 106a and 106b.

A selectable option would allow an advanced operator 101 to, when leaning back, also continue in reverse after zero speed is reached for braking 110, the brake 110 arrangement may contain a cable 114 and brake pad 115 and an electrical wiring array 201 associated with linking battery power to sensor and power source 203-213.

An motion detection example, during autonomous drive control 600 when a motor controller server 212a is configured to sense the drive wheels 107/108 motor speed may adjust with the motor 109 torque to keep the drive wheel 107/108 rotational velocities relatively similar, especially in situations when the front drive wheel 107 has more traction compared to the rear drive wheel 108 which may be sensed by a motor controller processor 212b which is configured to read the strain gauge sensors on the one or more motors 109a. 209b, and furthermore determine which drive wheel has more operator 101 weight and therefore more traction.

Accordingly the steering columns right handle 117 supports a right thumb throttle 119 assist the operator to control speed and trajectory, and the steering columns handles are utilized by the AB operator 101 for manually steering the AB 100.

As manually controlled AB 100 accordingly during manual drive mode 700 the AB operator 101 may disengage autonomous drive mode 600 settings to manually control the autonomous bicycle 100B. The autonomous drive mode ends operations of the deformation sensors 112 allow the operator to activate the steering columns right handle 117 and left handle 118 for manually steering the AB 100 during manual drive mode 700, and the AB operator 101 utilizes the thumb throttle 119 and the left thumb brake lever 120 for manually controlling motor velocity during manual drive mode 700.

In various elements the framework's front end 103 and a rear end 104 for attaching a front drive wheel 107 and rear drive wheel 108 via the suspension fork 111 providing a connection at the drive wheel axis, and the drive wheels 107 and 108 comprises an axle configured with bearings and bolting means for coupling a motor 109.

The brake arrangement linking to a left thumb brake lever 120 to slow down (decrease velocity) until zero speed is reached as the left thumb brake lever 120 engages a cable associated to a brake pad to slow or stop the drive wheel 109, the autonomous bicycle's brake 110 is common, however the cable is associated with the motor controller 212.

In various element the brake 110 arrangement may contain a cable 114 and brake pad 115 and an electrical wiring array 201 associated with linking battery power to sensor and power source 213-214. The framework further comprising a steering column 116, the steering may be autonomously controlled to steer the autonomous bicycle during autonomous drive mode operation by means of manually steering vis steering column handles 117-118.

In various elements the steering column 116 comprises a and control panel 400(CP) and a right handle 117 and a left handle 118. The control panel 400(CP) containing the control system components disclosed in FIG. 2 and FIG. 4A.

The steering column 116 is further configured with a base portion 121 and coupling means 122 for attaching or detaching the steering column 116 onto the front suspension fork 111a, front drive wheel 107 and brake 110 arrangements.

During manual drive mode 700, in one example to control the velocity setpoint of the autonomous bicycle 100A speed the operator 101 could engage the thumb throttle 119 or engage the left thumb brake lever 120.

In various elements the thumb throttle 119, the left thumb brake lever may be defined by different colors to help visually discern the accelerator from the brake this can be useful when operating at high speeds or with distractions.

In various elements the AB 100 framework's environment sensor array components housed within the steering column 116.

In various elements the AB 100 framework's front end 103 supports a front suspension fork 111a, a front drive wheel 107, and a front motor 109a; and the framework's rear end 104 support supports a rear suspension fork 111b, a rear drive wheel 108, and a rear motor 109b, (e.g., the drive wheels may be configured having spokes, tires, a rigid rim, a flexing rim or a combination thereof).

In greater detail FIG. 2A illustrates the autonomous bicycle framework 102 comprising a control panel 200 and an electrical wiring array 201, the control panel 400(CP) linking electrical devices and components to the ABCS 400 (contained within the control panel 400(CP)) and the User Interface System 800. The electrical wiring array 201 is configured for linking battery power directly to a compartment 200. The compartment 200 configured for containing LED lighting array 202, speakers 203, cameras 205, battery packs 214. The lighting array 202 including; LED head lamps 202a, LED turn signals 202b, braking lamps 202c, a LED cord 202d, the LED cord 202d can be synchronized to speakers 203.

Accordingly wherein ABCS environment sensor array is including but not limited to; LIDAR sensor 206 (e.g., 2D, 3D, color LIDAR), RADAR 207, sonar 208, load sensors 209, gyroscopic sensor 210, accelerometer 211. Respectively the load sensor 209 or “orientation sensor” is configured to measure an orientation of the operator's presence on the seat 105. The steering actuator 113, gyroscopic sensor 210 are adapted to maintain fore-and-aft balancing of the autonomous bicycle 100, and accordingly the accelerometer 211 and the motor controller 212 are associated to control a preferred battery power level. Accordingly, the steering actuator 204, load sensor 209, gyroscopic sensor 210, accelerometer 211b and motor controller 212 are electronically linked via a wiring array 201 to the power control module 213 contained within the compartment 200.

In various connectivity elements, wherein the compartment 200 provides a wired connection means for linking battery power to internal devices and to external devices, wherein the electrical wiring array 201 is connectively linked to a USB port 216, the USB port become connected to an external power source such as AC 110 outlet, via an external USB power cord 217.

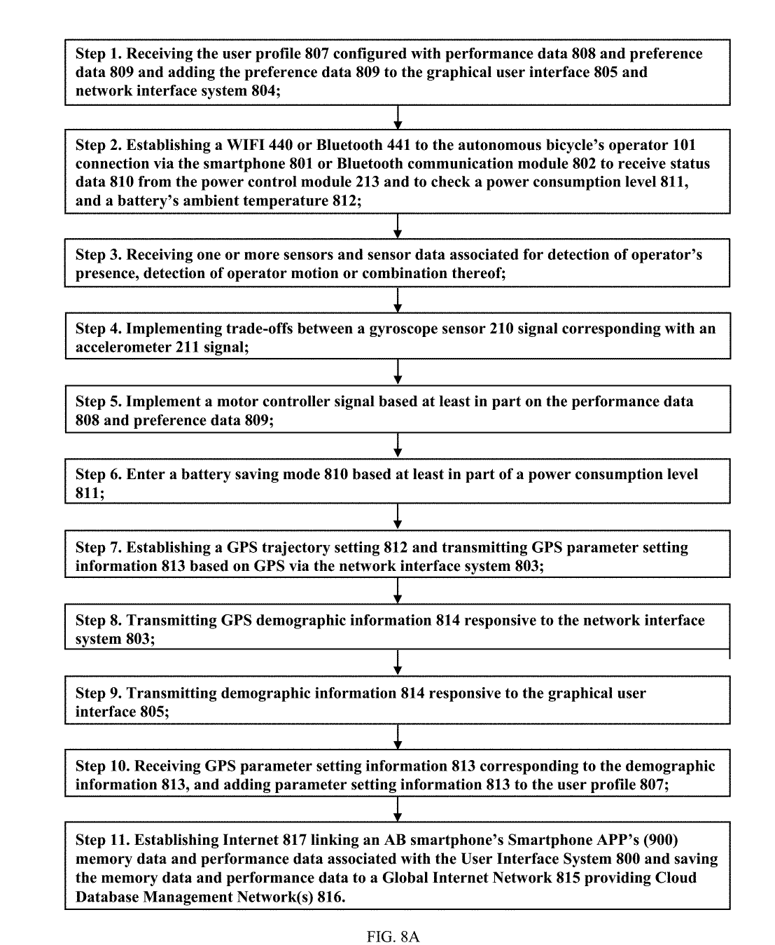

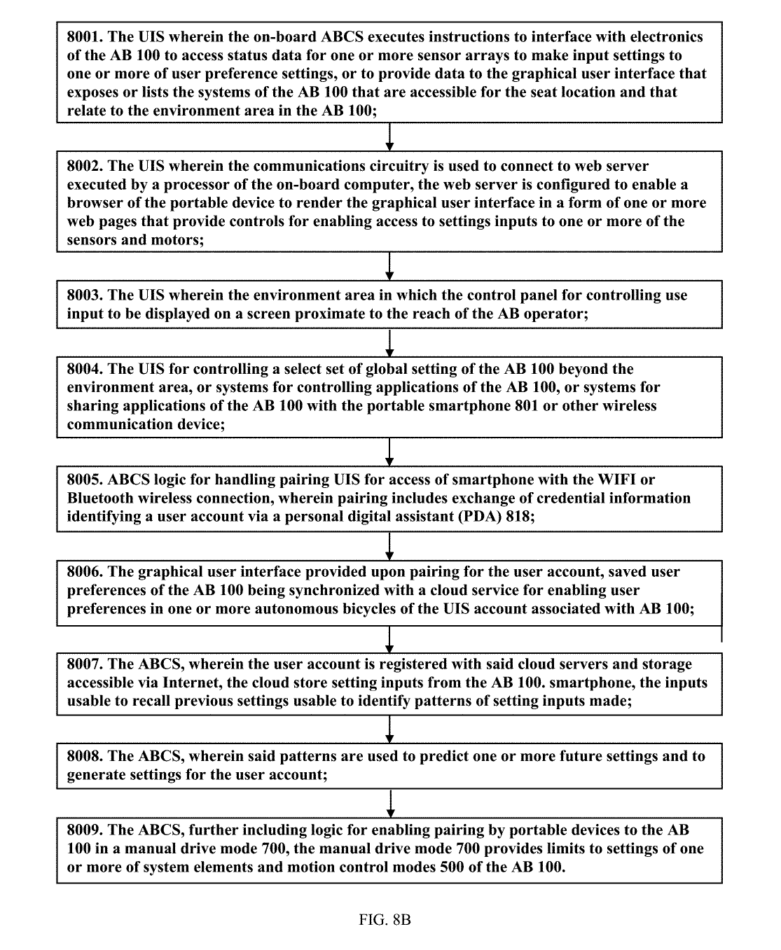

In FIG. 2B the Bluetooth connected devices, when paired, are linked to the autonomous bicycle controller system 400 by means of a built-in Bluetooth communication module 802, the Bluetooth communication module 802 transmits data signal associated with pairing with the motion control components, steering actuators 113, and the environment sensor array 205-211. The control panel 400(CP) further contains the wiring array 201 linking to the gyroscopic sensor 210, accelerometer 211, and the motor controller 212. Wherein the control panel 400(CP) components via a built-in Bluetooth communication mode 802, the Bluetooth communication module 802 configured as a wireless connection means for linking the autonomous bicycle controller system 400 to the user interface system 800, and the user interface system being WIFI linked or Bluetooth paired with the operator's Smartphone APP 900, detailed in FIG. 8 and FIG. 9.

FIG. 2B further illustrates the compartment 200 containing one or more removable battery packs set in a series which are charged by a battery charger 215, the battery charger 215 is governed by the power control module 213 providing sensor data 213a, the battery charger 215 providing a charging level 215a and sensor data 213a, said battery charger 215 is electrically linked to a USB port 216 to recharge the battery pack 214 from time to time from an external power outlet source providing external USB power cord 217, the USB power cord 217 can be stored inside the compartment 200, via an access panel 218, for later use to charge phones and other DC devices.

In various elements the power control module 213 further comprises a receiver 213b and a processor 213c for monitoring the battery charger's a charge level 215a associated with one or more removable battery packs 214a, 214b during a charging process. Wherein the battery charger 215, via wiring array 201 connects the battery packs 214a, 214b in a paralleled series. Respectively, the battery packs 214a, 214b when fully charged can be switched out and used later to extend operators riding time, the spent battery pack are placed back in the compartment or recharged later.

In greater detail FIG. 2C the frame is represented accordingly, wherein the compartment 200 contains an electrical wiring array 202 linking to a battery packs 214a, 214b to the power control module 213, and battery charger 215, wherein the battery charger subsequently connects to the USB power cord 217 and AC outlet or other power source.

Accordingly, the deformation sensor 112, steering actuators 113 are contained on sections of drive wheel 107, 108, and the motion sensors and cameras 205-211 are situated on sections of the framework 102 and sections of the steering column 216, the motor controller 212 is contained within a section of the compartment 200.

Respectively in autonomous drive mode 600 the gyroscopic sensor 210 (including fuzzy logic 210a) and an accelerometer 211 and provide data based on load sensor data 209a, gyroscope sensor data 210a and base on accelerometer sensor data 211a, and the motor controller 212 associated with a server 212a, a processor 212b, and motor controller sensor data 212c. Respectively the gyroscope sensor 210 providing an intelligent weight and motion controlling means, and an accelerometer 211 configured to measure balance which is achieved as soon as the AB operator 101 steps on the foot pegs 106a,b, and subsequently the preferred power level, associated with the motor controller 212, the deformation sensor 112 and the steering actuator 113.

Respectively, the AB 100 may be self-powered by regenerated power from the one or more drive wheel motors 109a, 109b, providing a minimal amount of regeneration power is captured to maintain a battery charge level 215a to run the motor controller 212 and allow the low-drag torque control 212d is useful when the battery 214 has been nearly depleted, a regenerative battery charging process is initiated by the braking activity 110 of slowing down or stopping. Accordingly, the velocity of the drive wheels 107/108 provides a motor 109 may be associated with a regenerative braking means 110 for maintaining a charge level 215a to the battery 214a and/or 214b.

FIG. 2C further illustrates a steering column 116 and a control panel 400(CP), the control panel 400(CP) configured with a touch display 218 and communications circuity 219 having connection to the built in Bluetooth communication module 802 and the autonomous bicycle controller system 400. The communications circuitry 219 is configured to interface with a wireless network for accessing the Internet, and pair to the user interface system 800, and smartphone 801, see FIG. 4 and FIG. 8. The communications circuitry 219 is configured to be hard wired to the steering column components 116-120, the drive wheel components 107, 108, the power control module components 212-215, the motion and environment sensor arrays 112, 204-212, and the Bluetooth paired devices; 202, 203,

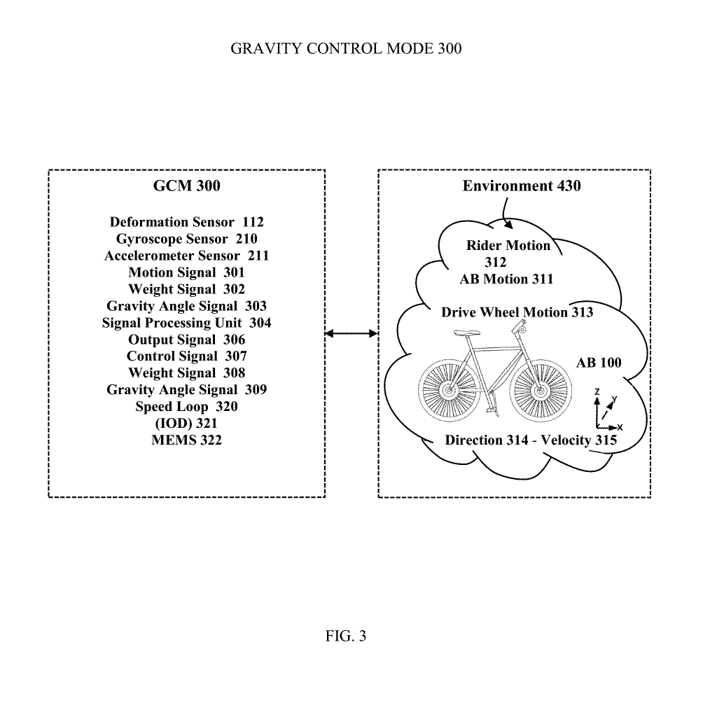

In greater detail FIG. 3A illustrates a control diagram of a Motion Assistant Gravity Control Mode 300 which may include for example, and a deformation sensor 112, a load sensor 209, a gyroscope sensor 210 an accelerometer sensor 211, a motion signal 301, a weight signal 302, a gravity angle signal 303, a signal processing unit 304, an output signal 306, control signal 307, a weight signal 308 and a gravity angle signal 309 environment 430, AB 100 motion 311, an operator motion 312 and the drive wheel's motion 313, direction 315, and velocity 316.

In various environments 430 the gyroscope sensor 210 and the accelerometer sensor 211 may measure a motion signal 301 of an operator's motion 312 by pushing a foot pegs 106, suspension forks 111, and/or a 3-dimension moving response of the AB's in the x, y, z direction 315 and velocity 316 associated with the operator's motion 312 and/or the example the AB's motion 311, or by a combination thereof.

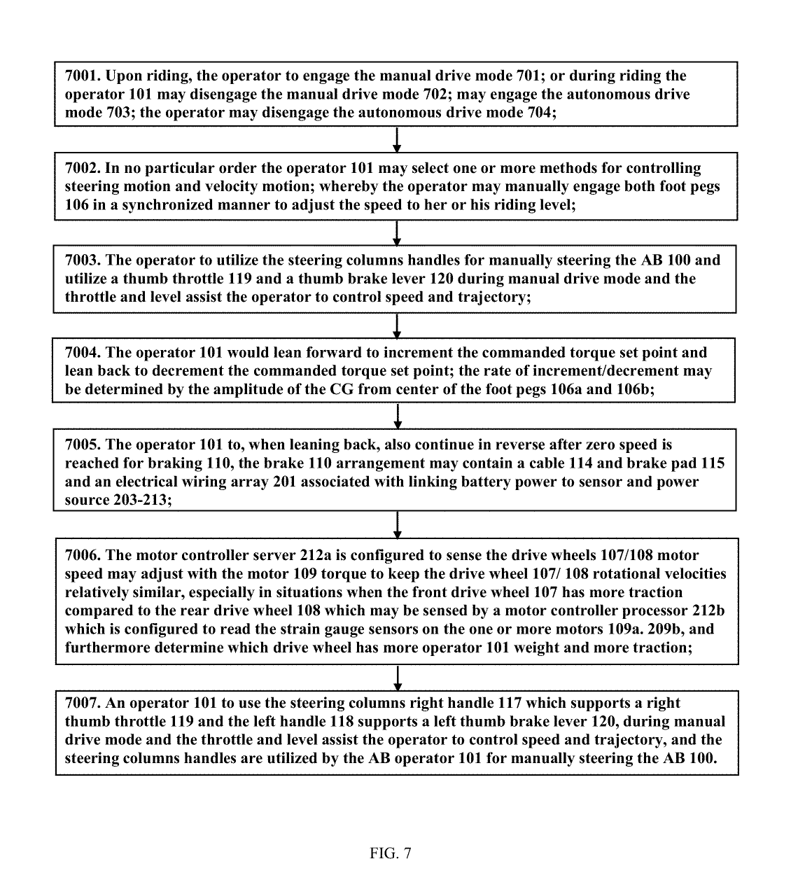

In one example, the motions 311/312 may include a predefined motion input 301, including for example, the operator 101 hopping on and/or off the AB 100. The operator utilizing one or more riding skills to associated with motion control operator 101 which include; to engage a drive mode 701-704, motion to engage propulsion and motion to engage trajectory, see FIG. 7 for further details.

In one example, a deformation sensor 112 may be computed by a weight signal 302 and a gravity angle signal 309 generated from one or more move control signals 307, including for example, forward, backward, accelerate, and/or brake signal 109a from a signal processing unit 304. The signal processing unit 304 may combine and process the deformation output signal 306 providing motion signals 301 to produce the one or more move control signals 307 relayed the autonomous drive mode 600.

In some aspects control signals 307 may control the AB 100 to move in a direction, including for example, a forward direction or a backward direction, or an initial orientation direction (IOD) 321. The direction of the AB's motion 311 may be determined based on the deformation output signal 306 associated with the weight signal 308 and the gravity angle signal 309.

In some aspects control signals may control the speed of the AB 100, for example, to accelerate or braking means 110. In one example, the speed of the AB's motion 311 may be determined based on operator's motion 312, such as shaking the AB 100. In another example, the speed of the AB motion 311 may be determined based on the deformation output signal 306 associated with the weight signal 308 and the gravity angle signal 309. Respectively, the deformation sensor comprises a strain gauge 112a configured to sense induced strain by imbalanced forces exerted upon the drive wheel 107, drive wheel 108 and the deformation sensor 112 to sense strain level 112b induced by an operator's weight exerted on the deformation sensor 112 to sense strain level induced by a rotation speed and twisting angle differences at a connection point generated at an connection of a suspension fork 111a of the drive wheel 107 attached on the framework's front end 103, and the deformation sensor 112 to sense strain level induced by a rotation speed and twisting angle differences at a connection point generated at a connection of a suspension fork 111b of the drive wheel 108 attached on the framework's rear end 104.

Accordingly, the load sensors 209 are contained between the seat 105 and foot pegs 106a, 106b, respectively the gyroscopic sensor 210 (with fuzzy logic 210a) and an accelerometer 211, the load sensor 209 providing data based on gyroscope sensor data 210a and base on accelerometer sensor data 211a, and a motor controller 212 configured having; a server 212a, a processor 212b, sensor data 212c and low-drag torque control 212d. Respectively the gyroscope sensor 210 providing an intelligent weight and motion controlling means via the motor 109, a steering actuator 113, the motor controller 212, and an accelerometer 211 configured to measure balance which is achieved as soon as the operator 101 sits on the seat 105 or places one or both feet on the foot pegs 106a, 106b.

Subsequently when operator 101 is detected on the seat 105 or on footing is on one or both foot pegs 106, the load sensors 209 accordingly activate to begin furnishing battery power to the drive wheel motor 109, wherein the load sensors 209 link to the power control module 213, the motor controller 212a or 212b, which governed by operator 101, ABCS 400 or a combination of both.

Another control method is to use the above described method to sense CG but to increment or decrement a torque set point in a torque controller loop instead of a speed loop 320. The operator 101 would lean forward to increment the commanded torque set point and lean back to decrement the commanded torque set point; the rate of increment/decrement may be determined by the amplitude of the CG from center of the foot pegs 106a and 106b.

A selectable option would allow an advanced operator 101 to, when leaning back, may also continue in reverse after zero speed is reached for braking 110 via cable and brake pad 114/115.

In greater detail FIG. 4 illustrates a diagram representing operations for an Autonomous Bicycle Control System 400 comprising operating processes and sensors via a sensor system, associated with processors providing sensor data, wherein the environment sensor array is configured to detect objects in environment and to determine an object track for objects, classify objects, track locations of objects in environment, and sensors to detect specific types of objects in the working environment, such as traffic signs/lights, road markings, lane markings and the like. The Autonomous Bicycle Control System 400 comprises one or more processor 401 and memory 402 for storing sensor data provided by an arrangement of environment sensors 206-211 elements and the power control module 213 contained within the framework 102, the environment sensors associated with ABCS may include but not limited to one or more of; a short-range LIDAR sensor 206, a radar sensor (ARS) 207 an IMU sensor 403 are situated on sections of the framework 102, and may utilize sonar 208. The one or more processors being configured to determine a location of the AB 100 in the environment, a localizer system 405 may receive sensor data 404 from an IMU sensor data 409. In some examples, sensor data received by localizer system 405 may not be identical to sensor system data 406 received by the perception system 407.

For example, perception system 407 may receive sensor system data 406 from one or more external environmental sensor array situated on section of the framework 102 and control panel 200; wherein the LIDAR sensor 206 (e.g., 2D, 3D, color LIDAR), RADAR 207, sonar 208, based on MEMS technology 322, other data is gathered by one or more video cameras 205 (e.g., image capture devices); whereas, localizer system 405 may receive sensor system data 406 including but not limited to global positioning system (GPS) 408 having data 408 including; inertial measurement unit (IMU) data 409, map data 410, route data 411, Route Network Definition File (RNDF) data 412 and odometry data 413, wheel encoder data 414, and map tile data 415. Accordingly, the localizer system 405, having a planner system 416 having memory 417 and may receive object data 418 from sources other than sensor systems, such as utilizing memory 417 via a data store 431 or Cloud Data Management 432 and Performance Management Network 433, a global satellite coordinate system 434.

Accordingly perception system 407 may process sensor data to generate object data 418 that may be received by the planner system 416. Object data 418 may include but is not limited to data representing object classification 419, detecting an object type 420, object track 421, object location 422, predicted object path 423, predicted object trajectory 424, and object velocity 425, object library 426 in an environment 430.

Accordingly the localizer system 404 may process sensor data, and optionally, other data, to generate position and orientation data 427, local pose data 428 that may be received by the planner system 416. The local pose data 428 may include, but is not limited to, data representing a location 429 in the environment 430 via (GPS) 408, (IMU) data 409, map data 410, route data 411, (RNDF) data 412 and odometry data 413, wheel encoder data 414, and map tile data 415, and the global satellite coordinate system 434 for example.

The following implementations described that includes a no matter in motion (such as video), and no matter at rest (still images), and text, graphics, or whether it be a picture of any that may be configured to display the image device. It may be implemented in devices or systems. More specifically, the implementation to be described include, but are not limited to, mobile phones, multimedia Internet enabled cellular telephones, mobile television receiver, a wireless device, smartphone, Bluetooth connected devices 203-212, a personal digital assistant (PDA) 818, a wireless e-mail receiver, hand-held or portable computers. Teachings herein also include, but are not limited to, electronic switching devices, radio frequency filters, sensors, accelerometers, gyroscopes, motion sensing devices, magnetometers, inertial components for consumer electronics, parts of consumer electronics products varactor, a liquid crystal device, an electrophoretic device, a driving method, such as manufacturing processes and electronic test equipment, can be used in non-display applications. Accordingly, the present teachings, not just limited to the implementation shown in the figures, has instead, a wide easily such that the apparent applicability to those skilled in the art.

The sensor system of the AB 100 comprising processors for determining, based at least in part on the sensor data, a location of the AB 100 within the environment 430, wherein the location 429 of the AB 100 identifies a position and orientation via load sensors 209 of the AB 100 within the environment 430 according to global coordinate system 431.

The ABCS is associated with calculating, based at least in part on the location 429 of the autonomous bicycle 100 and at least a portion of the sensor data 403 a trajectory 425 of the AB 100, wherein the trajectory 425 indicates a planned path associated GPS 408 with navigating the AB 100 between at least a first location 429a and a second location 429b within the environment 430.

The ABCS is associated with identifying, based at least in part on the sensor data 406, an object 421 within the environment 430; and determining a location of the object 421 in the environment 430, wherein the location 429 of the object 421 identifies a position and orientation 427 of the object within the environment according to the global coordinate system 431; and determining, based at least in part on the location 429 of the object 421 and the location of the AB 100, to provide a visual alert 432 from a light emitter 433.

The ABCS is associated with selecting a light pattern 434 from a plurality of light emitter 433 patterns, wherein a first one of light patterns 434 is associated with a first level of urgency of the visual alert, and a second one of the light patterns is associated with a second level of urgency of the visual alert; selecting, from a plurality of light emitters 433 of the AB 100, a light emitter 433 to provide the visual alert 432; and causing the light emitter 433 to provide the visual alert 432, the light emitter emitting light indicative of the light pattern 434 into the environment 430.

The ABCS is associated with calculating, based at least in part on the location of the object 421 and the trajectory 425 of the AB 100, an orientation 427 of the AB 100 relative to the location 429 of the object 406; selecting the light emitter is based at least in part on the orientation of the AB 100 relative to the location 429 of the object.

The ABCS is associated with estimating, based at least in part on the location 429 of the object 421 and the location 429 of the AB 100, a threshold event 435 associated with causing the light emitter 433 to provide the visual alert 432; and detecting an occurrence of the threshold event 435; and wherein causing the light emitter 433 of the AB 100 to provide the visual alert 432 is based at least in part on the occurrence of the threshold event 435.

The ABCS is associated with calculating, based at least in part on the location 429 of the object 421 and the location 429 of the AB 100, a distance between the AB 100 and the object 421; and wherein selecting the light pattern 434 is based at least in part on the distance, threshold event 335 according to a threshold distance 436 or a threshold time, and a second threshold distance 437.

The ABCS is associated with estimating light and configured with a setting for selecting the light pattern 434 is based at least in part on one or more of a first threshold event 435 according to a threshold distance or a threshold time, wherein the first threshold distance 436 is associated with the light pattern 434a and a second threshold distance 437 is associated with a different light pattern 434b, wherein the first threshold distance and the second threshold distance is less than a distance between the object 421 and the AB 100, and wherein the threshold time 436 is shorter in duration as compared to a time associated with the location 429 of the AB 100 and the location of the object being coincident with each other.

The ABCS is associated with calculating, based at least in part on the location 429 of the object 421 and the trajectory 425 of the AB 100, a time associated with the location 429 of the AB 100 and the location of the object being coincident with each other; and wherein causing the light emitter 433 of the AB 100 to provide the visual alert 432 is based at least in part on the time.

The ABCS is associated with determining an object classification for the object 421, the object classification determined from a plurality of object classifications, wherein the object classifications include a static pedestrian object classification, a dynamic pedestrian object classification, an object classification, and a dynamic car object classification; wherein selecting the light pattern 434 is based at least in part on the object 421 classification.

The ABCS is associated with accessing map data associated with the environment 430, the map data accessed from a data store of the AB 100, and determining position data and orientation data associated with the AB 100 and wherein determining the location 429 of the AB 100 within the environment 430 is based at least in part on the map data 410, the position data and the orientation data.

The ABCS is associated with selecting a different light pattern 434 from the plurality of light patterns based at least in part on a first location of the object before the visual alert is provided and a second location of the object after the visual alert is provided, and causing the light emitter 433 to provide a second visual alert, wherein the light emitter emits light indicative of the different light pattern into the environment 430.

Wherein the light emitter 433 includes a sub-section and the light pattern includes a sub-pattern 438 associated with the sub-section 439, the sub-section being configured to emit light indicative of the sub-pattern 438, wherein at least one of the sub-patterns 438 is indicative of one or more of a signaling functions of the AB 100 or a braking function 114/115 of the AB 100 and wherein at least one other sub-pattern 438 is indicative of the visual alert 432 receiving data representing a sensor signal 108a indicative of a rate of rotation of a drive wheel 108 of the AB 100; and modulating the light pattern 434 based at least in part on the rate of drive wheel's electric motor 109 rotation.

The planner system 417 may process the object data and the local via GPS 408 providing pose data 428 to compute a motion path (e.g., a trajectory 425 of the AB) for the AB 100 to travel through the environment 430. The computed path being determined in part by object data 421 in the environment 430 that may create an obstacle to one bicycles, skateboards or other vehicles which may pose a collision threat to the AB 100.

In various aspects the autonomous bicycle controller system 400 may employ a micro controller or central processors, memory, and sensors array to provide autonomous control to many different types of the autonomous bicycle 100. Autonomous bicycle control means that after initialization, the AB 100 moves and/or accomplishes one or more tasks without further guidance from the operator 101, even if the operator 101 is riding the AB 100, or the operator 101 is located within a few steps of the AB 100, or within the vicinity of the AB 100.

The link to an environmental sensor array link to a processing unit which communicates with the ABCS 400. The communication between the ABCS and the AB 100 may be carried on any suitable data bus with CAN (e.g. ISO 11898-1) and/or PWM buses preferred. Wirelessly via WIFI 440 and/or Bluetooth 441 the ABCS 400 synchronously links the user interface system 800 or (UIS) and to the Internet 442, Cloud Data 443 and Performance Management Network 444.

The ABCS 100 for providing autonomous control to the AB 100, comprising: UIS 800 that communicates with the AB 100 and provides instructions to the vehicle regarding acceleration, braking, steering or a combination thereof; the UIS 800 that communicates with and receives instructions from an operator 101, the instructions including task instructions, path planning information or both.

The ABCS is associated with an environmental sensor array 407 that receives sensor data from the AB 100 and communicates the sensor data 421 such data including AB 100 speed, compass heading, absolute position, relative position or a combination thereof. The ABCS is associated at least one sensor that monitors motion of the AB 100 including rate of acceleration, pitch rate, roll rate, yaw rate or a combination thereof and the at least one sensor that monitors motion includes the accelerometer, the gyroscope, and the motor controller 212. It said while calculating a friction pie from the tire and the road surface state in the current running state, a command value to the output adjusting means calculates the braking amount corresponding to the braking operation amount, the output adjusting means, controls the operation of the a steering actuator 205 for the front drive wheel 107, the rear drive wheel 108 and brake operations of both by sending a command value to the braking force control means of the motor controller 212 and functions of the motor controller 212a,b, wherein the front brake 110a and rear brake 110b are activated by the brake-by-wire type braking control means 114, the braking control is engage by operators leaning backward motion, by operators engaging a brake throttle/switch 120 or a combination thereof. A rate of acceleration, pitch rate, roll rate, yaw rate output adjusting means constituted in the ABCS, wherein the braking force of the angular velocity detected when the stability limit or greater than the threshold of the friction pie, the general control unit of the command value it is determined that sudden braking send to the braking control means for establishing stability limit or threshold grip of the front and rear wheel tires such that traveling always is controlled.

The ABCS is associated with programming for path planning to the AB 100 and such path planning includes marking a path of waypoints on a digitized geospatial representation, the waypoints mark a path that is the perimeter of a scan area that the AB 100 then scans; wherein the AB 100 scans the scan area by traveling to waypoints within the scan area, and respectively the ABCS 400 employs a digitized geospatial representation that provides absolute position of the AB 100 in creating the scan area or provides relative position through the use of an ad hoc grid.

In various aspects the ABCS 400 includes a mechanism for receiving communication from a smartphone 801 or the internet 442 such that an operator 101 can communicate with the AB 100 through the control panel 400(CP).

In greater detail FIG. 4A illustrates a flowchart for the Autonomous Bicycle Controller System 400 applied to the drive and motion processes to: 4001. Establish the deformation sensors 112 mounted directly to the suspension adapter 111 and/or mounted on the truck 110 to measure an induced stress caused by the operator's weight associated with the drive wheels 107/108 is configured to sense strain level 112c; 4002. Establish a deformation sensor 112 induced by a rotation speed and twisting angle differences at a connection point generated at an intersection of the drive wheel 107/108 and the framework 102 and the deformation sensor 112 to sense strain level induced by a rotation speed and twisting angle differences at a connection point generated at an intersection of a top portion of the drive wheels front end 103 and rear end 104 framework connections; 4003. Establish a gyroscope sensor 210 associated to sense inclination of the framework 102, when working, respectively the electric motor(s) 109 are configured to drive the wheels 107/108 only when the autonomous bicycle 100 is properly oriented via one or more load sensors 209 in a reasonable riding position, such as substantially level to the ground; 4004. Establishing a AB 100 initial orientation direction (IOD) 321 on the ground, and respective of the midpoint of the spinning center of gravity (CG) of the gyroscope sensor 210 and the accelerometer 211 and the activation of the motor 109 of 107/108 to engage motor controller 212 to turn on battery 214 to power forward momentum 603 and acceleration speed 603a; 4005. Detect operator's presence via a deformation sensor 112 attached to the suspension adapter 111, the deformation sensor to sense operator weight and center of gravity strain induced by forces exerted upon the front drive wheel 107 and rear drive wheel 108, and the deformation sensor to sense weight imbalance of the operator's 101 center of gravity to move linearly in response to a balance level of the autonomous bicycle 100 via a gyroscope sensor 210 attached to a section of the framework 102 ends 103, 104; 4006. Establish strain levels induced by a rotation speed and twisting angle differences within a suspension module 111 whereby the strain gauge 112a to sense induced strain by one or more imbalanced forces exerted upon the drive wheels 107/108.

As shown FIG. 4B continued: 4007. Establish operator posture during a riding activity 703 and determine an operator's motion involving employing drive mode operations 701-704, employ propulsion operations 705-715, and employ trajectory operations 709, 715, 716-719; 4008. Determination of one or more of a signaling functions of the AB 100 or a braking function 107 associated with sub-patterns 438 indicative of the visual alert 432 for receiving data representing a sensor signal 108a indicative of a rate of rotation of a drive wheel 108 of the AB 100; and modulating the light pattern 434 based at least in part on the rate of drive wheel's electric motor 109 rotation, and steering actuator 205; 4009. Employing a planner system 417 process for providing object data and local GPS 408 providing pose data 428 to compute a motion path (e.g., a trajectory 425 of the AB) for the AB 100 to travel through the environment 430; Determine the computed path being in part by object data 421 in the environment 430 that may create an obstacle to one or more other vehicles and/or may pose a collision threat to the AB 100; 4010. Initiate a variety of sensors operative to generate sensor data for an AB 100 located within an environment, cameras 204, environment sensor array associated with radar 206, sonar 207 and LIDAR 206 including light emitters operative to emit light into the environment 330; 4011 Determine a location of the object, wherein the location of the object identifies a position and orientation of the object within the environment of the autonomous bicycle 100; 4012. Provide the visual alert by emitting light indicative of the light pattern into the environment based at least in part on the location of the object and the trajectory of the AB 100, an orientation of the AB 100 which is relative to the location of the object to avoid the object.

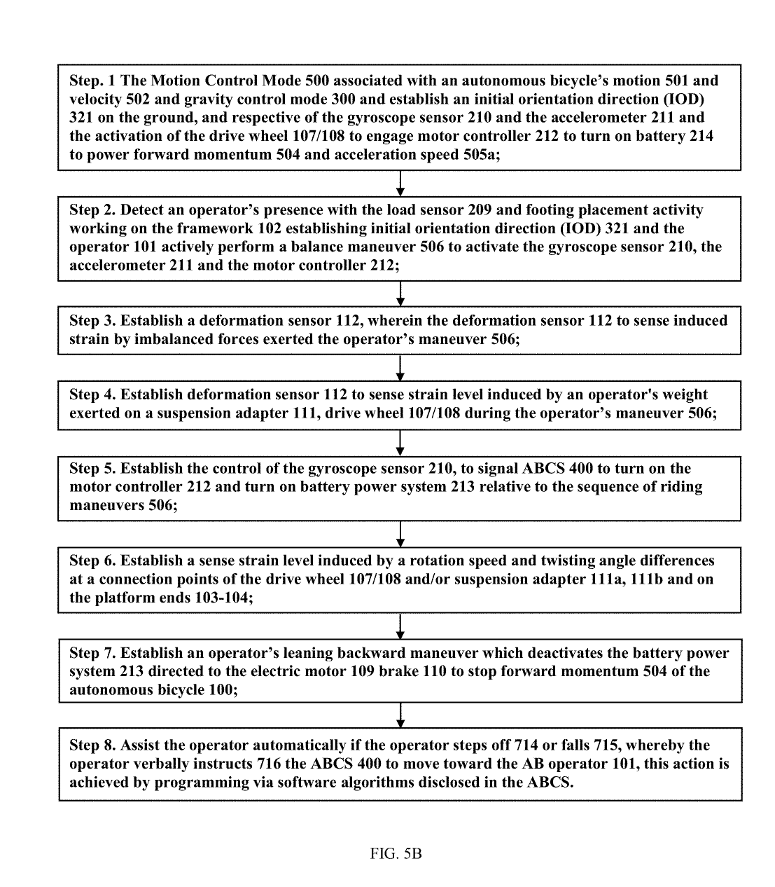

In greater detail FIG. 5A represents a diagram for a Motion Control Mode 500 operations and FIG. 5B represents a flowchart for a Motion Control Mode 500 associated with an autonomous skateboard's motion 501 and velocity 502 methodologies and Gravity Control Mode 300 comprising: Step. 1 The Motion Control Mode 500 associated with an autonomous bicycle's motion 501 and velocity 502 and gravity control mode 300 and establish an initial orientation direction (IOD) 321 on the ground, and respective of the gyroscope sensor 210 and the accelerometer 211 and the activation of the drive wheel 107/108 to engage motor controller 212 to turn on battery 214 to power forward momentum 504 and acceleration speed 505a; Step 2. Detect an operator's presence with the load sensor 209 and footing placement activity working on the framework 102 establishing initial orientation direction (IOD) 321 and the operator 101 actively perform a balance maneuver 506 to activate the gyroscope sensor 210, the accelerometer 211 and the motor controller 212; Step 3. Establish a deformation sensor 112, wherein the deformation sensor 112 to sense induced strain by imbalanced forces exerted the operator's maneuver 506; Step 4. Establish deformation sensor 112 to sense strain level induced by an operator's weight exerted on a suspension adapter 111, drive wheel 107/108 during the operator's maneuver 506; Step 5. Establish the control of the gyroscope sensor 210, to signal ABCS 400 to turn on the motor controller 212 and turn on battery power system 213 relative to the sequence of riding maneuvers 506; Step 6. Establish a sense strain level induced by a rotation speed and twisting angle differences at a connection points of the drive wheel 107/108 and/or suspension adapter 111a, 111b and on the platform ends 103-104; Step 7. Establish an operator's leaning backward maneuver which deactivates the battery power system 213 directed to the electric motor 109 brake 110 to stop forward momentum 504 of the autonomous bicycle 100; Step 8. Assist the operator automatically if the operator steps off 714 or falls 715, whereby the operator verbally instructs 716 the ABCS 400 to move toward the AB operator 101, this action is achieved by programming via software algorithms disclosed in the ABCS.

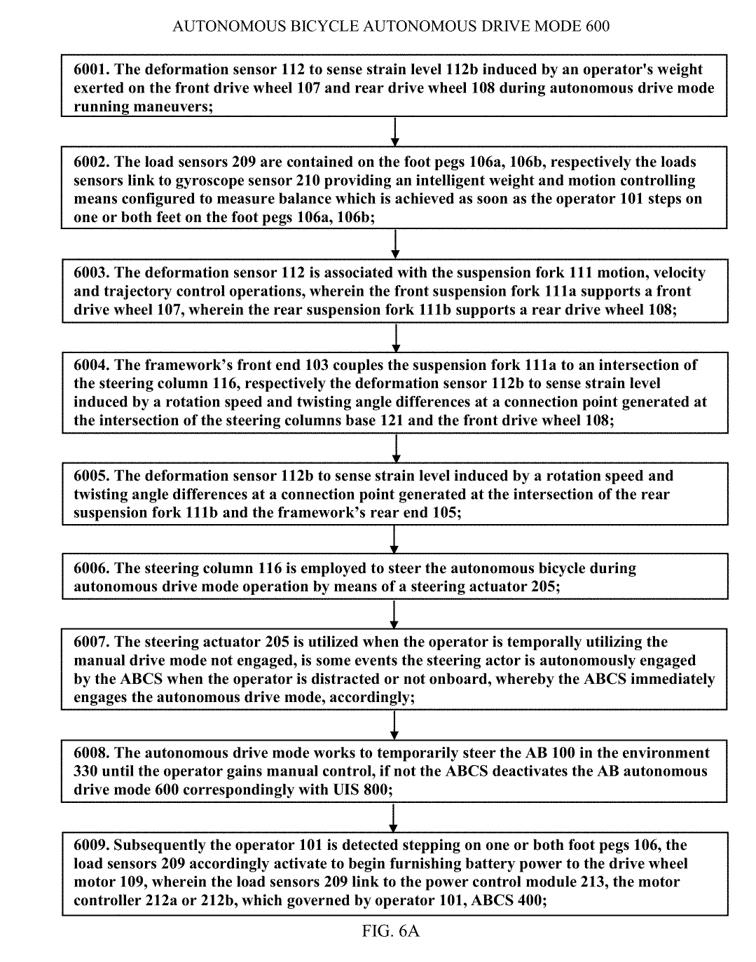

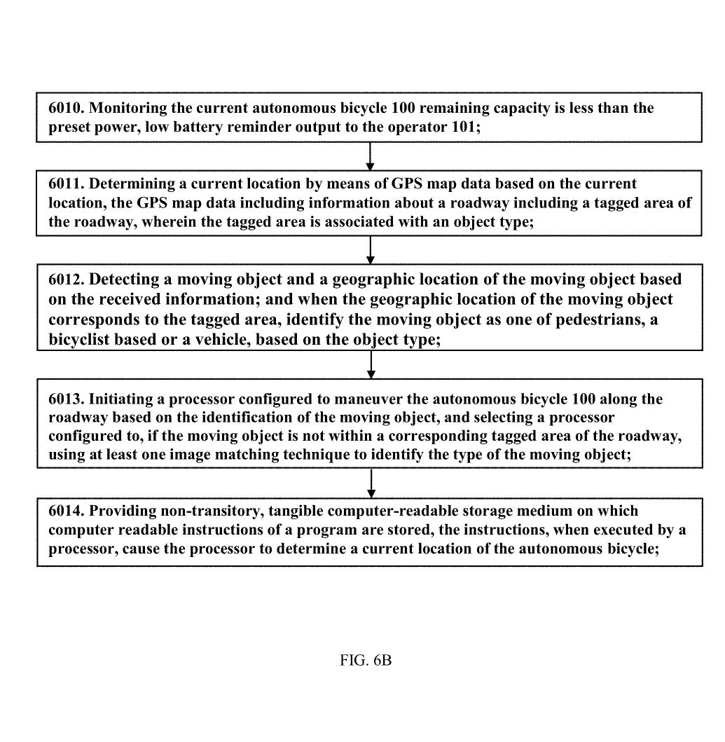

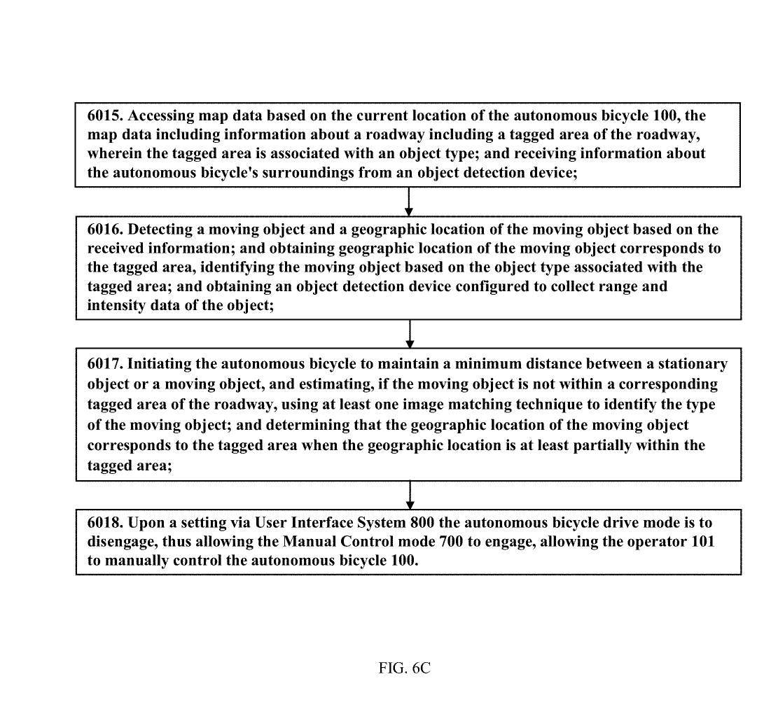

In greater detail FIG. 6A, FIG. 6B and FIG. 6C illustrates the Autonomous Drive Mode 600, the system comprising one or more processors for controlling an autonomous bicycle 100 upon operator activation, obtaining the user interface system 700 processors flowchart operation comprising: 6001. The deformation sensor 112 to sense strain level 112b induced by an operator's weight exerted on the front drive wheel 107 and rear drive wheel 108 during autonomous drive mode running maneuvers; 6002. The load sensors 209 are contained on the foot pegs 106a, 106b, respectively the loads sensors link to gyroscope sensor 210 providing an intelligent weight and motion controlling means configured to measure balance which is achieved as soon as the operator 101 steps on one or both feet on the foot pegs 106a, 106b; 6003. The deformation sensor 112 is associated with the suspension fork 111 motion, velocity and trajectory control operations, wherein the front suspension fork 111a supports a front drive wheel 107, wherein the rear suspension fork 111b supports a rear drive wheel 108; 6004. The framework's front end 103 couples the suspension fork 111a to an intersection of the steering column 116, respectively the deformation sensor 112b to sense strain level induced by a rotation speed and twisting angle differences at a connection point generated at the intersection of the steering columns base 121 and the front drive wheel 108; 6005. The deformation sensor 112b to sense strain level induced by a rotation speed and twisting angle differences at a connection point generated at the intersection of the rear suspension fork 111b and the framework's rear end 105; 6006. The steering column 116 is employed to steer the autonomous bicycle during autonomous drive mode operation by means of a steering actuator 205; 6007. The steering actuator 205 is utilized when the operator is temporally utilizing the manual drive mode not engaged, is some events the steering actor is autonomously engaged by the ABCS when the operator is distracted or not onboard, whereby the ABCS immediately engages the autonomous drive mode, accordingly; 6008. The autonomous drive mode works to temporarily steer the AB 100 in the environment 330 until the operator gains manual control, if not the ABCS deactivates the AB autonomous drive mode 600 correspondingly with UIS 800; 6009. Subsequently the operator 101 is detected stepping on one or both foot pegs 106, the load sensors 209 accordingly activate to begin furnishing battery power to the drive wheel motor 109, wherein the load sensors 209 link to the power control module 213, the motor controller 212a or 212b, which governed by operator 101, ABCS 400; 6010. Monitoring the current AB 100 remaining capacity is less than the preset power, low battery reminder output to the user; 6011. Determining a current location by means of GPS map data based on the current location, the GPS map data including information about a roadway including a tagged area of the roadway, wherein the tagged area is associated with an object type; 6012. Detecting a moving object and a geographic location of the moving object based on the received information; and when the geographic location of the moving object corresponds to the tagged area, identify the moving object as one of pedestrians, a bicyclist based or a vehicle, based on the object type; 6013. Initiating a processor configured to maneuver the autonomous bicycle 100 along the roadway based on the identification of the moving object, and selecting a processor configured to, if the moving object is not within a corresponding tagged area of the roadway, using at least one image matching technique to identify the type of the moving object; 6014. Providing non-transitory, tangible computer-readable storage medium on which computer readable instructions of a program are stored, the instructions, when executed by a processor, cause the processor to determine a current location of the autonomous bicycle; 6015. Accessing map data based on the current location of the AB 100, the map data including information about a roadway including a tagged area of the roadway, wherein the tagged area is associated with an object type; and receiving information about the AB's surroundings from an object detection device; 6016. Detecting a moving object and a geographic location of the moving object based on the received information; and obtaining geographic location of the moving object corresponds to the tagged area, identifying the moving object based on the object type associated with the tagged area; and obtaining an object detection device configured to collect range and intensity data of the object; 6017 Initiating the autonomous bicycle to maintain a minimum distance between a stationary object or a moving object, and estimating, if the moving object is not within a corresponding tagged area of the roadway, using at least one image matching technique to identify the type of the moving object; and determining that the geographic location of the moving object corresponds to the tagged area when the geographic location is at least partially within the tagged area; 6018. Upon a setting via User Interface System 800 the autonomous bicycle drive mode is to disengage, thus allowing the Manual Control mode 700 to engage, allowing the operator 101 to manually control the autonomous bicycle 100.

In greater detail FIG. 7 represents a diagram of a Manual Drive Mode 700 representing an operator 101 of an autonomous bicycle 100 utilizing one or more riding skills to employ drive mode operations 701-704, employ propulsion operations 705-715, and employ trajectory operations 709, 715, 716-719. To commence propulsion steps include: 7001. Upon riding, the operator to engage the manual drive mode 701; or 7002. During riding the operator 101 may disengage the manual drive mode 702; may engage the autonomous drive mode 703; the operator may disengage the autonomous drive mode 704. 7002. In no particular order the operator 101 may select one or more methods for controlling steering motion and velocity motion; whereby the operator may manually engage both foot pegs 106 in a synchronized manner to adjust the speed to her or his riding level; 7003. The operator to utilize the steering columns handles for manually steering the ASB 100 and utilize a thumb throttle 119 and a thumb brake lever 120 during manual drive mode and the throttle and level assist the operator to control speed and trajectory; 7004. The operator 101 would lean forward to increment the commanded torque set point and lean back to decrement the commanded torque set point; the rate of increment/decrement may be determined by the amplitude of the CG from center of the foot pegs 106a and 106b; 7005. The operator 101 to, when leaning back, also continue in reverse after zero speed is reached for braking 110, the brake 110 arrangement may contain a cable 114 and brake pad 115 and an electrical wiring array 201 associated with linking battery power to sensor and power source 203-213; 7006. The motor controller server 212a is configured to sense the drive wheels 107/108 motor speed may adjust with the motor 109 torque to keep the drive wheel 107/108 rotational velocities relatively similar, especially in situations when the front drive wheel 107 has more traction compared to the rear drive wheel 108 which may be sensed by a motor controller processor 212b which is configured to read the strain gauge sensors on the one or more motors 109a. 209b, and furthermore determine which drive wheel has more operator 101 weight and therefore more traction; 7007. An operator 101 to use the steering columns right handle 117 which supports a right thumb throttle 119 and the left handle 118 supports a left thumb brake lever 120, during manual drive mode and the throttle and level assist the operator to control speed and trajectory, and the steering columns handles are utilized by the AB operator 101 for manually steering the AB 100.

Respectively the autonomous bicycle controller system 400 may be required to assist the operator 710 automatically if the operator 101 steps off foot pegs 106a, 106b, whereby the operator verbally instructs the ABCS 400 to move toward the operator 101, this action is achieved by programming via software algorithms disclosed in the ABCS 400.

In various aspects the autonomous bicycle controller system 400 may be employed to provide full autonomous control accomplished without any further guidance from when the operator 101, this action is achieved once the operator disengages the Manual Drive Mode 700.

In various aspects the autonomous bicycle controller system 400 may be requested by the operator to assist the operator during riding activity 706, whereby, the operator may instruct ABCS 400 to link to a micro-processor or processor of the user interface system 800 to temporary deactivate the manual control mode 700 and switch over to engage the Autonomous Drive Mode 600, thus allowing selective or minimal supervision from the operator 101 thereby the operator discontinues controlling the autonomous bicycle 100 (e. g, semiautonomous), or vice versa, switch over to manual drive and regains control respectively, these driving modes may be alternated over a period of time during riding events.

In one or more elements the communication established between the ABCS and the autonomous bicycle 100 may be carried on any suitable data bus with CAN (e.g. ISO 11898-1) and/or PWM buses, working wirelessly via WIFI 440 and/or Bluetooth 441, the autonomous bicycle controller system 400 synchronously links the ABCS the user interface system 800 to compute a motion path in one or more environments 430.

In greater detail FIG. 8A exemplifies a User Interface System 800 utilized to establish wireless communication link between an operator 101 of an autonomous bicycle 100 for controlling said autonomous bicycle 100, the wireless communication link achieved by a smartphone 801 comprising a Bluetooth communication module 802 configured as a wireless a link, linking the autonomous bicycle controller system to the user interface system. Bluetooth communication module 802 also configured for providing computer readable-instructions 803 which are entered by the operator 101. Wherein, the smartphone 801 configured to transmit the operator's 101 computer readable-instructions 803 associated with: a network interface system 804 and a graphical user interface 805 configured with multiple server prompt 806 scenarios associated with following steps: Step 1. Receiving the user profile 807 configured with performance data 808 and preference data 809 and adding the preference data 809 to the graphical user interface 805 and network interface system 804; Step 2. Establishing a WIFI 440 or Bluetooth 441 to the autonomous bicycle operator 101 connection via the smartphone 801 or Bluetooth communication module 802 to receive status data 810 from the power control module 213 and to check a power consumption level 811, and a battery's ambient temperature 812; Step 3. Receiving a load sensor 209 signal to receive status data sensing the operator's presence; Step 4. Implementing trade-offs between a gyroscope sensor 210 signal corresponding with an accelerometer 211 signal; Step 5. Implement a motor controller signal based at least in part on the performance data 808 and preference data 809; Step 6. Enter a battery saving mode 810 based at least in part of a power consumption level 811; Step 7. Establishing a GPS trajectory setting 812 and transmitting GPS parameter setting information 813 based on GPS via the network interface system 803; Step 8. Transmitting GPS demographic information 814 responsive to the network interface system 803; Step 9. Transmitting demographic information 814 responsive to the graphical user interface 805; Step 10. Receiving GPS parameter setting information 813 corresponding to the demographic information 813, and adding parameter setting information 813 to the user profile 807; Step 11. Establishing Internet 817 linking a smartphone's Smartphone APP's (900) memory data and performance data associated with the User Interface System 800 and saving the memory data and performance data to a Global Internet Network 815 providing Cloud Database Management Network(s) 816.

In greater detail FIG. 8B exemplifies a User Interface System 800 utilized to establish wireless communication link between an operator 101 of an autonomous bicycle 100 and an autonomous bicycle controller system 400 associated with mobile app: 8001. The UIS wherein the on-board ABCS executes instructions to interface with electronics of the AB 100 to access status data for one or more sensor arrays to make input settings to one or more of user preference settings, or to provide data to the graphical user interface that exposes or lists the systems of the AB 100 that are accessible for the seat location and that relate to the environment area in the AB 100; 8002. The UIS wherein the communications circuitry is used to connect to web server executed by a processor of the on-board computer, the web server is configured to enable a browser of the portable device to render the graphical user interface in a form of one or more web pages that provide controls for enabling access to settings inputs to one or more of the sensors and motors; 8003. The UIS wherein the environment area in which the control panel for controlling use input to be displayed on a screen proximate to the reach of the AB operator; 8004. The UIS for controlling a select set of global setting of the AB 100 beyond the environment area, or systems for controlling applications of the AB 100, or systems for sharing applications of the AB 100 with the portable smartphone 801 or other wireless communication device; 8005. ABCS logic for handling pairing UIS for access of smartphone with the WIFI or Bluetooth wireless connection, wherein pairing includes exchange of credential information, the credential information identifying a user account via a personal digital assistant (PDA) 818, wherein the credential information includes one of a user name, or a password, or biometric data of a passenger, or a pin, or code, or a name, or a word, or combinations of two or more thereof; 8006. The graphical user interface provided upon pairing for the user account includes one or more saved user preferences regarding one or more of the systems of the AB 100, said saved user preferences being synchronized with a cloud service for enabling use of the said user preferences in one more autonomous bicycles when the user account is used in said one or more autonomous bicycles; 8007. The ABCS, wherein the user account is registered with said cloud service that include servers and storage accessible over the Internet, the cloud services are configured to store setting inputs from time to time from the AB 100 or the smartphone, the inputs usable to recall previous settings for use and usable to identify patterns of setting inputs made; 8008. The ABCS, wherein said patterns are used to predict one or more future settings and to generate recommendations of settings for the user account. 8009. The ABCS, further including logic for enabling pairing by portable devices to the AB 100 in a manual drive mode 700, the manual drive mode 700 provides limits to settings of one or more of system elements and motion control modes 500 of the AB 100.

In greater detail FIG. 9 schematically illustrates a diagram representing a Smartphone APP 900 accordingly, the operator 101 utilizes their smartphone 801 in real time to access the virtual controller settings 901 established from multiple server prompt 806 scenarios which allows an autonomous bicycle operator 101 during Manual Drive Mode 700 to manually control the velocity of one or more electric motors 109 and to manually control the trajectory of the autonomous bicycle 100 in a real time environment with the use of a Smartphone APP 900.

Accordingly, in one or more applications, the Smartphone APP 900 may update future over-the-air software & firmware and manage social media and the internet of things via a Global network Global Internet Network 815 providing Cloud Database Management Network(s) 816, or Cloud Data Management 432 and Performance Management Network 433, a global satellite coordinate system 434. The Smartphone APP 900 allows the AB operator 101 to select listings on a menu 902 by the finger prompting 903 (i.e., swiping gestures).

Respectively the Smartphone APP 900 controls of the following settings in relation to the virtually controlled autonomous bicycle components 916 configured to be wirelessly control via user interface, virtual settings listed on the menu 902 as: a power on 903 and off switch 904, a Power switches 905; a Driving modes 906; Beginner Drive Mode A, Normal Drive Mode B, Master Drive Mode C; a Motor controller 907; a Battery power level 908; a Charging gauge 909; GPS 910: a mapping a route 910A, a distance 910B; LED Lamp switch 911/206-207; User Music 912; Speaker setting 913; Camera setting 914; and an Anti-theft alarm for the alarm module switch 915 and Bluetooth connected devices mentioned in FIG. 1-FIG. 4 associated as virtual settings and virtual data in the mobile app.

The smartphone's mobile app communicates between the ABCS wirelessly via WIFI 440 and/or Bluetooth 441 the ABCS 400 synchronously links the user interface system 800 or (UIS) and to the Internet 442, Cloud Data 443 and Performance Management Network 444, and/or Global Internet Network 815 providing Cloud Database Management Network(s) 816.

Some implementations provide automatic display mode selection by the reference hierarchy. For example, such an implementation may provide automatic display mode selection for mobile display devices can correspond to a set of each display mode displays the parameter setting, the display parameter setting includes color depth setting, brightness setting (brightness setting), the color gamut setting (color gamut setting), the frame rate setting, contrast setting, gamma setting and obtain. Some implementations may involve a trade-off between the display parameter setting and power consumption. In some instances, one of the criteria may correspond to the application or “application” running on the display device. Various battery status conditions, such as ambient light conditions, may correspond to the display mode. In some implementations, the display parameter setting information, or other device configuration information can be updated according to information received by the display device from another device, such as from the server.

In order to optimize the display criteria for a particular user, some implementations, obtained with the method comprising creating a user profile, and controlling the display such as the display of the mobile display device in accordance with the user profile. In some examples, the display criteria may include brightness, contrast, bit depth, resolution, color gamut, frame rate, power consumption, or gamma. In some implementations, audio performance, touch/gesture recognition, speech recognition, target tracking, in order to optimize the other display device operation, such as head tracking, the user profile may be used. In some such instances, volumes, such as the relative amounts of bass and treble, in order to optimize in accordance with personal hearing profile of the audio settings for mobile display device user (personal hearing profile), associated within the user profile. In some implementations, the display parameter setting information, or other device configuration information corresponding to data in a user profile may be received by another device from a display device such as a server. In some examples, the corresponding data in the user profile may include demographic data.

In various implications the AB operator 101 to understand, various It may provide greatly optimized display settings, and the corresponding level of power consumption to the user with respect to the scenario. Implementations involving user profile, according to the wishes or characteristics of a particular user, can result in additional level of optimization. In some implementations, the default display parameter setting information, can be determined according to a known demographic of users, may be used to control the display without the need of an associated user input. Implementations involving be distributed over a period of time that the process of building a user profile, without placing an excessive burden on the user during the initial setup, the detailed user profile may allow it to be built. For example, a plurality of use of mobile display device, a plurality of illumination conditions and use conditions or may include a plurality of applications used, through a series of brief vision testing or A/B image prompt dispersed over a period of time, limited Although not a substantial amount of information about the visual function of the users, including color perception can be obtained through the display device without imposing a significant burden on the user. In some implementations, the period of time, a plurality of the day, may be a week or a month. To optimize the visual quality of the display for the user, visual function information may be used. In some instances, in order to increase the color intensity of the user to struggle to perceive visual function information may be used. In some implementations, in order to reduce the power user spent on color depth, may visual function information used to optimize the display power consumption. Furthermore, resulting acquired considerable amount of information about the user's intention that wants to obtain an image quality power and exchange, thereby, it may allow additional display power saving. In some examples, the power can be expressed as a battery life. Some of the user interface disclosed herein include, but are not limited to, information about the user's intention that wants to obtain an image quality in exchange for battery life, user preference information, user information, including visual function information, to allow it to be suitably acquired.

As disclosed in more detail elsewhere herein, some methods may involve obtaining various types of user information for the user profile. Some implementations may involve providing a user prompt for user information and obtaining the user information in response to a user prompt. Some such implementations may involve providing via a mobile display device user prompt for user information. For example, user information, biometric information, the user name, may include user identification information such as a user preference data. In some implementations, in order to associate the user information to a specific user profile, user identification information may be used. For example, it may be useful to distinguish user information obtained from a plurality of users of a single mobile display device.

Some user information, the user to respond to prompts, without the need for such entering the information may be obtained “passively”. For example, some user information, how, when, or where mobile display device may be obtained according to whether used. Such user information, the setting of the user selection, mobile display device location information or the mobile display device is used for an application type, mobile display devices that run on the content or mobile display device provided by a mobile display device time, mobile display device may include environmental conditions used. In some instances, setting the user selection for mobile display devices, text size setting may include brightness setting, or audio volume setting. According to some implementations, environmental conditions may include a temperature or ambient light intensity. As in the user information obtained through the user response, information can be passively acquired over a number of time periods which may include the use of mobile display devices.

Some implementations may allow a plurality of user profiles user maintenance. For example, the user may generally have habitual access to outlet to charge the mobile display device. During such time, the user, in accordance with a first user profile prefer the display image quality than battery life, it may want to try to control the mobile display device settings.

The preference data in a user profile. In some such implementations, such as a user profile stored in the memory of the mobile display device may involve creating or updating a user profile maintained locally via the network interface of the mobile display device, it may also involve sending a user profile information to another device. For example, other devices may be capable of creating or updating a user profile server.

The user interface system is the portion of the ABCS that communicates with the operator required to provide instructions, as shown in FIG. 9.

Another class of sensors includes antennae for sending and receiving information wirelessly, and includes RF, UWB and antennae for communications such as discussed elsewhere in this application. RFID tags may also be used to send and receive information or otherwise identify the AB 100. Moreover, RFID tags may also be used to receive positioning information or receive instructions and/or task performing information.

Preferably, the sensors are solid state devices based on sensor output signal may be in any data format useable by the processing unit, but preferably will be digital. Furthermore, wireline or wireless communication links may be utilized to transfer signals between the sensor array and the processing unit.

For all communication that takes place within the ABCS or between the ABCS and outside components, any suitable protocol may be used such as CAN, USB, Firewire, JAUS (Joint Architecture for Unmanned Systems), TCP/IP, or the like. For all wireless communications, any suitable protocol may be used such as standards or proposed standards in the IEEE 802.11 or 802.15 families, related to Bluetooth, WiMax, Ultrawide Band or the like. For communication that takes place between the ABCS and a central computer, protocols like Microsoft Robotics Studio or JAUS may be used. For long range communication between the ABCS and the operator, existing infrastructure like internet or cellular networks may be used. For that purpose, the ABCS may use the IEEE 802.11 interface to connect to the internet 422 or may be equipped with a cellular modem.

In greater detail FIG. 9 schematically illustrates a diagram representing a Smartphone APP 900 accordingly, the operator 101 utilizes their smartphone 801 to access the virtual controller settings 901 which allows operator 101 to control one or more Bluetooth devices with their Smartphone APP 900. Accordingly, the Smartphone APP 900 which can update future over-the-air software & firmware and manage social media and the internet of things via a Global network or Cloud Data Management 432 and Performance Management Network 433, a global satellite coordinate system 434. The Smartphone APP 900 allows the vehicle rider 101 to select Bluetooth connected devices; 1202-2112 virtual versions, accessible on a menu 902 by the finger prompting 903 (i.e., swiping gestures).

Respectively the autonomous bicycle's Smartphone APP 900 controls of the following settings in relation to the virtually control setting; 904. Power ON switch, 905 Power OFF switch 905, Driving modes 906-908, Beginner Drive Mode A 906, Normal Drive Mode B 907, Master Drive Mode C 908, Motor controller 909, Battery power level 910, Charging gauge 911, GPS 912: mapping a route 912A, distance 912B, LED Lamp switch, 913a, 913b, User Music 914, Speaker setting 915, Camera setting 916, Anti-theft alarm for the alarm module switch 917.

The present invention also comprises a method of path planning for an AB Path planning is providing a plurality of waypoints for the AB to follow as it moves. With the current method, path planning can be done remotely from the AB, where remotely means that the human operator is not physically touching the AB and may be meters or kilometers away from the AB or locating the operator 101.

The method of path planning comprises marking a path of waypoints on a digitized geospatial representation and utilizing coordinates of the way points of the marked path. Marking a path comprises drawing a line from a first point to a second point.

Any of several commercially available digitized geospatial representations that provide absolute position (e.g. GPS coordinates) may be used in this method and include Google Earth and Microsoft Virtual Earth. Other representations with absolute position information may also be used such as those that are proprietary or provided by the military.

Moreover, digitized geospatial representations with relative position information may also be used such as ad hoc grids like those described in U.S. Patent Publication 20050215269. The ad hoc grids may be mobile, stationary, temporary, permanent or combinations thereof, and find special use within building and under dense vegetative ground cover where GPS may be inaccessible. Other relative position information may be used such as the use of cellular networks to determine relative position of cell signals to one another.

Combinations of ABCS absolute and relative position information may be used, especially in situations where the AB travels in and out of buildings or dense vegetation.

The ABCS 400 coordinates of the waypoints of the marked path are then utilized, whether that means storing the data for later use, caching the data in preparation for near term use or immediately using the data by communicating the data to an outside controller (e.g. an ABCS). For example, the data may be communicated to the processing unit of the ABCS, such as through the operator interface. The processing unit may then issue instructions through the use interface system 800 to operate the AB, or otherwise store the data in the processing unit.

Moreover, other types ABCS path planning may also be utilized for example, recording the movement of the vehicle when operated by a human could be used to generate waypoints. Other types of manual path planning may also be used. In addition, path planning may be accomplished through the use of image recognition techniques. For example, planning a path based on a camera 105 mounted to the platform 102 to avoid objects. In another embodiment, path planning may be accomplished identifying portions of a digitized geospatial representation that is likely to indicate a road or street suitable for the AB to travel on.

With any type of path planning, the generated waypoint data may be manipulated through hardware or software to smooth the data, remove outliers or otherwise clean up or compress the data to ease the utilization of the data.

Moreover, the marked path may include boundary conditions (e.g. increasingly hard boundaries) on either side of the path to permit the AB to select a path that avoids objects that may be found on the original marked path.

In various aspects the autonomous bicycle controller system 400 may employ a micro controller or central processors, memory, sensors to provide autonomous control to many different types of the autonomous bicycle 100. Autonomous control means that after initialization, the vehicle moves and/or accomplishes one or more tasks without further guidance from a human operator, even if the human operator is located on or within the vicinity of the autonomous bicycle 100.

The ABCS also includes an operator interface. The operator interface is the portion of the AB that communicates with the operator (e.g., a human being or central computer system). For all autonomous AB's, at some point, a human operator is required to at least initiate or re-initiate the AB 100. To do this, the operator interface receives instructions (e.g., voice instruction or virtual finger gestures) from the operator, as shown in FIG. 9.

Another class of sensors includes antennae for sending and receiving information wirelessly, and includes RF, UWB and antennae for communications such as discussed elsewhere in this application. RFID tags may also be used to send and receive information or otherwise identify the AB 100. Moreover, RFID tags may also be used to receive positioning information or receive instructions and/or task performing information.

Preferably, the sensors are solid state devices based on MEMS technology 322 as these are very small, are light weight and have the necessary accuracy while not being cost prohibitive. Each utilized sensor provides a suitable output signal containing the information measured by the sensor. The sensor output signal may be in any data format useable by the processing unit, but preferably will be digital. Furthermore, wireline or wireless communication links may be utilized to transfer signals between the sensor array and the processing unit.

The link to an environmental sensor array link to a processing unit which communicates with the autonomous bicycle controller system 400 (ABCS). The communication between the ABCS and the autonomous bicycle 100 may be carried on any suitable data bus with CAN (e.g. ISO 11898-1) and/or PWM buses preferred. Wirelessly via WIFI 440 and/or Bluetooth 441 the autonomous bicycle controller system 400 synchronously links the manual drive mode 700 with the user interface system 800.

Throughout the present disclosure, a particular embodiment of the example may be initiated in a range format. Range of type descriptions are merely for convenience and brevity and should not be construed as an inflexible limitation on the disclosed range.

The described embodiments of the invention are intended to be merely exemplary and numerous variations and modifications will be apparent to those skilled in the art. All such variations and modifications are intended to be within the scope of the present invention as defined in the appended claims.

1. An autonomous bicycle comprising:
a framework, wherein the framework comprising, a steering column, a thumb throttle, a thumb brake lever, a seat, foot pegs, front and rear drive wheels including one or more motors;
a power control module, one or more batteries, a battery charger;
an autonomous bicycle controller system;
a motion sensor array, an environmental sensor array associated with said autonomous bicycle controller system;
one or more sensor signals and sensor data associated for detection of operator's presence, detection of operator motion or combination thereof;
wherein said autonomous bicycle controller system receives sensor data from said environmental sensor array and from motion sensor array;
a built in Bluetooth communication module; wherein the Bluetooth communication module linking to; a smartphone, Internet, Cloud or a combination thereof;
wherein the Bluetooth communication module linking to objects in an environment of said autonomous bicycle;
a user interface system interface that communicates with an autonomous bicycle and provides instructions to said autonomous bicycle regarding acceleration, braking, steering, trajectory or a combination thereof;
a processing unit having software for communicating with said autonomous bicycle, said user interface system, said motion sensor array, said environmental sensor array or a combination thereof;
an autonomous drive mode providing autonomous control to said autonomous bicycle for a period of time;
a manual control mode providing manual control to said autonomous bicycle for a period of time;
wherein said user interface system that communicates with and receives instructions from an operator of said autonomous bicycle, the instructions including task instructions, path planning information or both;
wherein said user interface system that wirelessly communicates with power control module, gravity control mode, motion sensor array, environmental sensor array or a combination thereof;
wherein said user interface system wirelessly communicates with autonomous bicycle operator via WIFI or Bluetooth smartphone;
wherein said Bluetooth communication module linking said autonomous bicycle controller system to the user interface system;
a Smartphone APP; wherein the user interface system being associated with the autonomous bicycle operator's Smartphone APP;
wherein said Smartphone APP connecting autonomous bicycle operator to said autonomous bicycle controller system.

2. The autonomous bicycle of claim 1 in which said framework further comprising:
the steering column further comprising:
the thumb throttle to control speed;
the thumb brake lever to control braking;
one or more sensors for detection of operator's presence or for detection of operator motion;
foot pegs configured having one or more sensors for detection of operator's presence or for detection of operator motion;
a compartment that is contained within a section of said framework;
a control panel;
wherein said control panel containing the autonomous bicycle controller system;
motion sensor array and environment sensor array;
one or more motor controllers contained with said compartment;
a built-in Bluetooth communication module contained with said compartment or contained on a section of said framework;
a wiring array, said wiring array linking battery power to the motion sensor array and the environment sensor array;
one or more removable batteries set in a series which are charged by a battery charger, wherein the battery charger is governed by the power control module providing sensor data, charging data or a combination thereof;
said electric wiring array electrically linked to a USB port to an external power source of said autonomous bicycle framework.

3. The autonomous bicycle of claim 1 wherein said autonomous bicycle controller system monitors motor controller operating conditions associated with said motor, battery level, power control module, charging battery or a combination thereof.

4. The autonomous bicycle of claim 1 in which said framework further comprising and containing a wiring array, LED lamps, speakers, wherein said LED lamps, speakers, truck, sensor array, cameras, and batteries linking to one or one wiring arrays contained within or attached to a section or portions of said framework.

5. The autonomous bicycle of claim 1 wherein said user interface system communicates with said autonomous bicycle controller system via WIFI or Bluetooth, wherein said Bluetooth communication module links said autonomous bicycle to operator's smartphone.

6. The autonomous bicycle of claim 1 said autonomous bicycle controller system further comprising:
a gravity control mode, configured to establish an autonomous bicycle's initial orientation direction (TOD) on the ground, speed, trajectory, position information, sensor array information or a combination thereof;
said gravity control mode further comprising a motion sensor array including; a deformation sensor, a load sensor, a gyroscope sensor, an accelerometer sensor;
wherein the load sensors to detect an operator's presence on said autonomous bicycle, seat, or framework portion;
wherein the gyroscope sensor to detect operator actively performing balance maneuver, steering maneuver or a combination thereof;
wherein the accelerometer to engage motor controller to turn on battery to power forward momentum, acceleration speed;
wherein the deformation sensor to sense induced strain by imbalanced forces exerted the operator's maneuvers;
wherein said deformation sensor to sense strain level induced by an operator's weight exerted on a suspension adapter, on a drive wheel or a combination thereof;
wherein the gyroscope sensor to signal ABCS to turn on the motor controller, turn on battery power system relative to the sequence of riding maneuvers.

7. The autonomous bicycle of claim 1 said autonomous bicycle controller system further comprising:
the motion control mode configured to:
establish a sense strain level induced by a rotation speed and twisting angle differences of an operator's leaning motion;
regulate the battery power directed to one or more motors, leaning backward which deactivates the battery power directed to one or more motors of said autonomous bicycle;
establish a sense strain level induced by a rotation speed and twisting angle differences of an operator's leaning motion direction;
wherein the deformation sensor to sense the center of gravity (CG) of the operator;
establish a desired speed by a speed controller loop;
establish the rate of increment/decrement determined by the amplitude of the CG from center;
accelerate (increase velocity), or slow down (decrease velocity) until zero speed is reaching a braking means of the one or more motor's drive torque setpoint;
monitor motion of the autonomous bicycle including rate of acceleration, pitch rate, roll rate, yaw rate or a combination thereof;
monitor one or more motors via motor sensors and sensor data.

8. The autonomous bicycle of claim 1, wherein said environmental sensor array further configured to receive sensor data from said autonomous bicycle controller system and communicates the sensor data to said user interface system such data including said autonomous bicycle operator motion and autonomous bicycle motion providing velocity, trajectory or a combination thereof.

9. The autonomous bicycle of claim 1, wherein the environmental sensor array further comprising one or more autonomous bicycle devices, collision avoidance sensors, LIDAR, short range sonar, short range radar, a camera based system or a combination thereof.

10. The autonomous bicycle of claim 1, wherein the environmental sensor array processors associated with waypoints mark a path that is the perimeter of a scan area that the autonomous bicycle then scans.

11. The autonomous bicycle of claim 1 wherein said autonomous bicycle controller system configured to:
initiate environment sensors of the environment sensor array operative to generate sensor data for an autonomous bicycle located within an environment;
establish LIDAR's light emitters, the light emitters operative to emit light into the environment of said autonomous bicycle;
determine a location of the object, wherein the location of the object identifies a position and orientation of the object within the environment;
provide the visual alert by emitting light indicative of the light pattern into the environment based at least in part on the location of the object and the trajectory of the autonomous bicycle;
establish an orientation of autonomous bicycle which is relative to the location of the object to avoid the object.

12. The autonomous bicycle of claim 1, said the environmental sensor array of said autonomous bicycle further configured:
wherein the autonomous bicycle controller system is programmed to provide path planning to the autonomous bicycle and such path planning includes the environment sensor array marking a path of waypoints on a digitized geospatial representation;
wherein the waypoints mark a path that is the perimeter of a scan area that the autonomous bicycle sensor array then scans;
wherein the environment sensor array scans the scan area by traveling to waypoints within the scan area;
wherein said autonomous bicycle controller system employs a digitized geospatial representation that provides absolute position of the autonomous bicycle in creating the scan area or provides relative position through the use of the environment sensor array.

13. The autonomous bicycle of claim 1, wherein the autonomous bicycle controller system further comprising:
software, processors, memory, storage, wireless communication or a combination thereof associated with said autonomous bicycle;
wherein software programmed to provide path planning to the autonomous bicycle and such path planning includes marking a path of waypoints on a digitized geospatial representation associated with said autonomous bicycle;
wherein a processor configured to, if the moving object is not within a corresponding tagged area of the roadway, using at least one image matching technique to identify the type of the moving object, determine a current location of the autonomous bicycle;
wherein a processor to monitor the current or remaining capacity of battery power, low battery reminder output to the user of said autonomous bicycle;
determine a current location by means of GPS map data based on the current location, the GPS map data including information about a roadway detect a moving object and a geographic location of the moving object based on the received information associated with said autonomous bicycle.

14. The autonomous bicycle of claim 1, wherein the autonomous drive mode configured for:
providing non-transitory, tangible computer-readable storage medium on which computer readable instructions of a program are stored, the instructions;
accessing map data based on the current location, the map data including information about a roadway including a tagged area of the roadway;
detecting a moving object and a geographic location of the moving object based on the received information;
obtaining geographic location;
identify the type of the moving object; and determining that the geographic location of the moving object corresponds to the tagged area when the geographic location is at least partially within the tagged area;
wherein upon a setting via user interface system the autonomous bicycle drive mode is to disengage, thus allowing the manual control mode to engage, allowing the operator to manually control the autonomous bicycle temporarily;
wherein initiate instruction of the user interface system, via said autonomous bicycle drive mode, to disengage, thus allowing the manual control mode to engage, allowing the operator to manually control the autonomous bicycle temporarily;
one or more riding skills to employ drive mode operations, employ propulsion operations;
employ trajectory operations; engage the manual drive mode;
disengage the manual drive mode, via operator.

15. The autonomous bicycle of claim 1, wherein the manual control mode processes further configured to:
upon riding said autonomous bicycle an operator may:
engage the manual drive mode, disengage the manual drive mode, engage the autonomous drive mode, or a combination thereof;
select one or more methods for controlling steering motion and velocity motion; whereby the operator may:
manually engage both foot pegs in a synchronized manner to adjust the speed to her or his riding level;
utilize the steering columns handles for manually steering;
engage a load sensor associated with a foot peg;
commence a forward speed;
commence a braking activity for achieving slowing or stopping motor speed;
reverse motor direction;
steer in an angular left direction;
steer in angular right direction;
summon said autonomous bicycle to drive directly to her or him;
provide instruction via smartphone, via a Smartphone APP, via virtual instruction or a combination thereof.

16. The autonomous bicycle of claim 1, wherein the processing unit of said autonomous bicycle having software for communicating with said autonomous bicycle and thus to allow said operator to summon the autonomous bicycle, said user interface system, said frame motion sensor array, environmental sensor array or a combination thereof to obtain information from objects in environment surround said autonomous bicycle whilst said autonomous bicycle is independently operating without an operator riding onboard.

17. The autonomous bicycle of claim 1 wherein said user interface system of said autonomous bicycle configured for:
establishing a WIFI or Bluetooth connection for wirelessly communicating with operator, receiving said user profile configured with performance data, preference data, adding the preference data to the graphical user interface, network interface system or a combination thereof;
establishing Internet, linking a smartphone's Smartphone APP's;
establishing memory data and performance data associated with user interface system;
wherein memory storage includes a removable data storage so that stored data can be retrieved in the absence of wireline or wireless communications network, Internet or a combination thereof;
saving the memory data and performance data to a Global Internet Network providing Cloud Database Management Network(s).

18. An autonomous bicycle controller system comprising:
an environmental sensor array to obtain information from objects in environment surround an autonomous bicycle;
a user interface system interface that communicates with said autonomous bicycle;
wherein said user interface provides instructions to said autonomous bicycle regarding acceleration, braking means, steering, trajectory by one or more autonomous bicycle motion sensor devices;
wherein the user interface system that communicates with and receives instructions from an operator or user, the instructions including task instructions, path planning information or both of said autonomous bicycle;
wherein the user interface system that wirelessly communicate, via WIFI or built in Bluetooth module communication module linked to operators' smartphone of said autonomous bicycle;
wherein implementing Bluetooth communication module to receive or transmit operational status data associated with said autonomous bicycle;
wherein calibrate a power control module, to check a power consumption level, battery's ambient temperature of said autonomous bicycle;
wherein establish communicating GPS trajectory setting, GPS parameter setting information, GPS demographic information responsive to a global network system of said autonomous bicycle;
transmitting demographic information responsive to the graphical user interface, adding parameter setting information to the user profile;
wirelessly communicate, via WIFI or Bluetooth linked smartphone associated with said autonomous bicycle;
wherein the user interface system being associated with a Smartphone APP, sensor array, a motorized bicycle wheel array, power control module, autonomous bicycle controller system, environmental sensor array or a manual control means associated with a combination thereof;
wherein the user interface system comprising a processing unit having software for communicating with one or more autonomous bicycles and thus to allow operator to summon one or more autonomous bicycles verbally via smartphone;
an environmental sensor array to obtain information from objects in environment surround said autonomous bicycle whilst said autonomous bicycle is independently operating without an operator riding onboard.

19. An autonomous bicycle user interface system comprising:
a mobile app linking an autonomous bicycle controller system associated with the user interface system of the autonomous bicycle;
the mobile app receiving instructions from an operator of the autonomous bicycle, the instructions including motion controlling instructions, path planning instruction or a combination thereof;
the mobile app obtaining a customized user profile configured with performance data, preference data, adding the preference data to the graphical user interface, network interface system or a combination thereof of the autonomous bicycle;
the mobile app implementing a load sensor signal to receive status data sensing the operator's presence of said autonomous bicycle;
the mobile app implementing trade-offs between a gyroscope sensor signal corresponding with an accelerometer signal of said autonomous bicycle;
the mobile app implementing a motor controller signal based at least in part on the performance data, preference data of said autonomous bicycle;
the mobile app implementing a battery saving mode based at least in part of a power consumption level;
the mobile app a power control module, to check a power consumption level, battery's ambient temperature of said autonomous bicycle;
the mobile app communicating GPS trajectory setting, GPS parameter setting information, GPS demographic information or combination thereof of said autonomous bicycle;
the mobile app transmitting demographic information responsive to the graphical user interface, adding parameter setting information to the user profile of said autonomous bicycle;
the mobile app establishing Internet, linking a smartphone's Smartphone APP's an application of said autonomous bicycle;
the mobile app establishing a WIFI or Bluetooth connection, accessing Internet of said autonomous bicycle;
the mobile app establishing memory data and performance data associated with user interface system of said autonomous bicycle;
the mobile app saving the memory data and performance data to a Global Internet Network providing Cloud Database Management Network of said autonomous bicycle;
the mobile app connecting user to said autonomous bicycle controller system's Bluetooth communication module to receive status data from operator's smartphone;
the mobile app to virtually access or govern operations of one or more autonomous bicycle control modes of said autonomous bicycle;
the mobile app associated with update future over-the-air software and firmware of said autonomous bicycle;
the mobile app associated to manage social media music, via the internet of things provided by global network of said autonomous bicycle;
the mobile app to engage processing unit having software associated for communicating with said autonomous bicycle controller system to link to environmental sensor array;
the mobile app associated to obtain information from objects in environment surrounding said autonomous bicycle;
the mobile app comprising processors providing battery charge status of said autonomous bicycle;
the mobile app comprising processors providing charging level data of said autonomous bicycle.

20. The autonomous bicycle controller system of claim 1, claim 18, claim 19 further comprising:
software associated with an autonomous bicycle controller system, the software programming providing algorithm for one or more mobile apps monitoring operational processes of said autonomous bicycle;
software associated with an autonomous bicycle controller system, the software programming providing algorithm for said autonomous bicycle sensor array, motorized bicycle wheel array, power control module, autonomous bicycle controller system, environmental sensor array or a combination thereof;
software associated with an autonomous bicycle controller system, the software programming providing algorithm for said autonomous bicycle to independently operate without an operator riding onboard;
software associated with an autonomous bicycle controller system, the software programming providing algorithm for operator to summon the autonomous bicycle verbally via smartphone;
software associated with an autonomous bicycle controller system, the software programming providing algorithm for said autonomous bicycle to independently operate without an operator riding onboard;
software associated with an autonomous bicycle controller system, the software programming providing algorithm configured for operator instruction, one such instruction, to summon an autonomous bicycle, via autonomous drive mode, to autonomously drive over to her or him;
user preference settings, operation performance, user performance data or a combination thereof to store data as memory in a Cloud network, Global Internet Network providing Cloud Database Management Network(s).
